(19) United States
(12) Patent Application Publication
(10) Pub. No.: US 2018/0288660 A1
(43) Pub. Date: Oct. 4, 2018

(54) CONNECTION CONTROL APPARATUS AND CONNECTION CONTROL METHOD

(71) Applicant: FUJITSU LIMITED, Kawasaki-shi (JP)

(72) Inventors: Hirotake Honda, Sendai (JP); HIDEHARU SHAKO, Yokohama (JP); Youji Nakata, Sapporo (JP)

(73) Assignee: FUJITSU LIMITED, Kawasaki-shi (JP)

(21) Appl. No.: 15/936,546

(22) Filed: Mar. 27, 2018

(30) Foreign Application Priority Data
Mar. 31, 2017 (JP) 2017-072971

(51) Int. Cl. H04W 36/00; H04L 29/06; H04W 48/16; H04W 8/24; H04W 36/30

(52) U.S. Cl. CPC H04W 36/0077; H04W 36/0038; H04W 36/30; H04W 48/16; H04W 8/24; H04L 63/0846

(57) ABSTRACT

An apparatus for connection control includes: a memory; a processor coupled to the memory and configured to execute a receiving process configured to receive, via a second wireless apparatus installed near a first wireless apparatus, identification information transmitted from a terminal that is located within a range of a first signal from the second wireless apparatus, the identification information being information configured to identify the terminal, and execute a transmitting process configured to transmit configuration information to the terminal via the second wireless apparatus when the terminal identified by the identification information is allowed to access to the first wireless apparatus that acts as a connection point for the terminal, the configuration information including a parameter for accessing the first wireless apparatus.

### CROSS-REFERENCE TO RELATED APPLICATION

This application is based upon and claims the benefit of priority of the prior Japanese Patent Application No. 2017-072971, filed on Mar. 31, 2017, the entire contents of which are incorporated herein by reference.

### FIELD

The embodiments discussed herein are related to a connection control apparatus and a connection control method.

### BACKGROUND

Recently, with the expansion of wireless communication technologies, wireless LAN is being introduced as a replacement for the wired local area networks (LANs) of the past, even in organizations such as businesses. From the perspective of providing mobility, wireless LAN has many merits, such as reduced network wiring construction costs, improved productivity by expanding the degree of freedom in the locations where terminals are set up, and in the realization of a paperless office through data sharing. Also, from the perspective of providing communication infrastructure, wireless LAN also has merits such as providing Internet connectivity for visitors, utilization as a backup link in times of a wired LAN fault, and as an efficient way to expand a LAN.

Examples of the related art include Japanese Laid-open Patent Publication No. 2016-72671 and Japanese Laid-open Patent Publication No. 2016-178385.

### SUMMARY

According to an aspect of the invention, an apparatus for connection control includes: a memory; a processor coupled to the memory and configured to execute a receiving process configured to receive, via a second wireless apparatus installed near a first wireless apparatus, identification information transmitted from a terminal that is located within a range of a first signal from the second wireless apparatus, the identification information being information configured to identify the terminal, and execute a transmitting process configured to transmit configuration information to the terminal via the second wireless apparatus when the terminal identified by the identification information is allowed to access to the first wireless apparatus that acts as a connection point for the terminal, the configuration information including a parameter for accessing the first wireless apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram for describing a first half of an overview of a connection control system according to the embodiments;

FIG. 1B is a diagram for describing a second half of an overview of a connection control system according to the embodiments;

FIG. 2 is a diagram illustrating a functional configuration of a control PC and a terminal according to Embodiment 1;

FIG. 3 is a diagram illustrating a data storage example in a data table according to Embodiment 1;

FIG. 4 is a diagram illustrating a hardware configuration of a connection control system according to Embodiment 1;

FIG. 5 is a diagram illustrating a configuration of a WiFi connection control system according to Embodiment 1;

FIG. 6 is a diagram illustrating an example of application of the WiFi connection control system according to Embodiment 1;

FIG. 7 is a diagram for describing operation in Case 1-1 of the WiFi connection control system according to Embodiment 1;

FIG. 8 is a diagram for describing operation in Case 1-2 of the WiFi connection control system according to Embodiment 1;

FIG. 9 is a diagram for describing operation in Case 1-3 of the WiFi connection control system according to Embodiment 1;

FIG. 10 is a diagram for describing operation in Case 1-4 of the WiFi connection control system according to Embodiment 1;

FIG. 11 is a diagram illustrating a data storage example in a data table according to Embodiment 2;

FIG. 12 is a diagram illustrating a configuration of a WiFi connection control system according to Embodiment 2;

FIG. 13 is a diagram illustrating an example of application of the WiFi connection control system according to Embodiment 2;

FIG. 14A is a diagram for describing a first half of operation in Case 2-1 of the WiFi connection control system according to Embodiment 2;

FIG. 14B is a diagram for describing a second half of operation in Case 2-1 of the WiFi connection control system according to Embodiment 2;

FIG. 15A is a diagram for describing a first half of operation in Case 2-2 of the WiFi connection control system according to Embodiment 2;

FIG. 15B is a diagram for describing a second half of operation in Case 2-2 of the WiFi connection control system according to Embodiment 2;

FIG. 16A is a diagram for describing a first half of operation in Case 2-3 of the WiFi connection control system according to Embodiment 2;

FIG. 16B is a diagram for describing a second half of operation in Case 2-3 of the WiFi connection control system according to Embodiment 2;

FIG. 17 is a diagram illustrating a data storage example in a data table according to Embodiment 3;

FIG. 18 is a diagram illustrating a configuration of a WiFi connection control system according to Embodiment 3;

FIG. 19 is a diagram illustrating an example of application of the WiFi connection control system according to Embodiment 3;

FIG. 20A is a diagram for describing a first half of operation in Case 3-1 of the WiFi connection control system according to Embodiment 3;

FIG. 20B is a diagram for describing a second half of operation in Case 3-1 of the WiFi connection control system according to Embodiment 3;

FIG. 21 is a diagram illustrating a data storage example in a data table according to Embodiment 4;

FIG. 22 is a diagram illustrating a configuration of a WiFi connection control system according to Embodiment 4;

FIG. 23 is a diagram illustrating an example of application of the WiFi connection control system according to Embodiment 4;

FIG. 24A is a diagram for describing a first part of operation in Case 4-1 of the WiFi connection control system according to Embodiment 4;

FIG. 24B is a diagram for describing a second part of operation in Case 4-1 of the WiFi connection control system according to Embodiment 4;

FIG. 24C is a diagram for describing a third part of operation in Case 4-1 of the WiFi connection control system according to Embodiment 4;

FIG. 25 is a diagram illustrating a data storage example in a data table according to Embodiment 5;

FIG. 26 is a diagram illustrating a configuration of a WiFi connection control system according to Embodiment 5;

FIG. 27 is a diagram illustrating an example of application of the WiFi connection control system according to Embodiment 5;

FIG. 28A is a diagram for describing a first half of operation in Case 5-1 of the WiFi connection control system according to Embodiment 5; and

FIG. 28B is a diagram for describing a second half of operation in Case 5-1 of the WiFi connection control system according to Embodiment 5.

### DESCRIPTION OF EMBODIMENTS

Along with the expanded usage of wireless LAN, some issues like the following have also occurred. From the perspective of communication degradation due to radio wave interference, with wireless LAN, since multiple pieces of equipment communication by using a limited frequency band, communication degradation occurs readily as the number of connected equipment increases. Even if multiple access points (APs) are installed, care has to be taken in the installation spacing and channels used, while in addition, phenomena such as a concentration of connections to a specific AP or a change in the surround environment may also occur, and it is difficult to ensure continually stable communication quality. Also, from the perspective of security measures, with wireless LAN, since radio waves reach even into unintended areas, security measures that anticipate phenomena such as eavesdropping, unauthorized access, and the transmission of large quantities of packets (jamming) by malicious third parties are demanded. In addition, since individual access rights are granted to legitimate users, such as making a public LAN available to general users while having employees connect to the company's private LAN, high-level skills are demanded for installation, administration, and operations.

For example, in a WiFi (registered trademark) control system of the related art, each terminal freely connects to an AP, and thus imbalances in the number of connected terminals among APs occur readily, while in addition, the system is also readily susceptible to the influence of radio wave interference or the like due to access from a terminal distanced a long way from an AP. Also, once a terminal has connected to an AP, the connection with the initially connected AP is maintained as long as the radio waves arrive, and thus even if another AP with more favorable communication quality exists, a process of switching to the other AP is not performed. Furthermore, as long as the service set identifier (SSID) and password (PWD) are known, a terminal is able to connect to an AP even from a common space such as a hallway, and thus there is a risk of eavesdropping and unauthorized access by malicious third parties. These are factors which lower the wireless LAN connection rate.

According to an aspect of the present disclosure, a technology capable of improving the connection rate is provided.

Hereinafter, embodiments of a connection control apparatus and a connection control method disclosed in this application will be described in detail with reference to the drawings. However, the connection control apparatus and the connection control method disclosed in this application are not limited by the following embodiments.

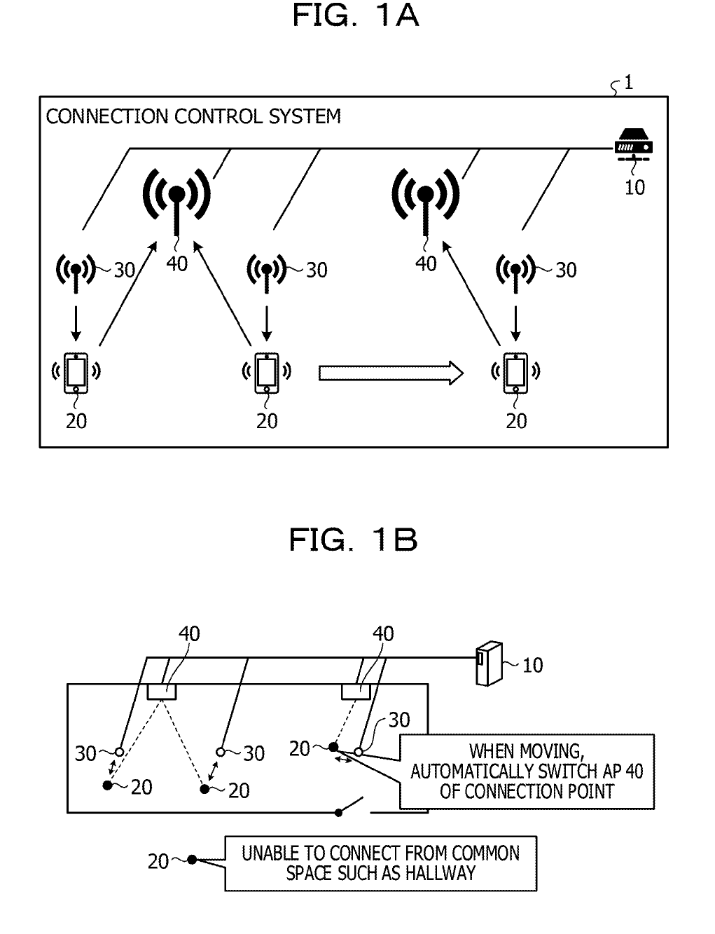

FIG. 1A is a diagram for describing a first half of an overview of a connection control system 1 according to the embodiments. As illustrated in FIG. 1A, in the connection control system 1, a control personal computer (PC) 10 may broadcast a presence of connection points such as WiFi access points (APs) 40 to each terminal 20 through Bluetooth (registered trademark) Low Energy Access Points (BLE APs) 30. With this arrangement, each terminal 20 may be connected to an optimal WiFi AP 40, and a stable WiFi connection environment may be constructed for the system as a whole. Also, the terminals 20 themselves switch among the connection point WiFi APs 40 automatically, and thus users do not have to change settings themselves. The WiFi APs 40 are one example of a first wireless apparatus, while the BLE APs 30 are one example of a second wireless apparatus. The BLE APs 30 may be arranged inside the wireless areas of the WiFi APs 40. Multiple BLE APs 30 may be arranged inside the wireless area of a single WiFi AP 40. Also, the BLE APs 30 and the WiFi APs 40 may be arranged so that part of the wireless area of a WiFi AP 40 overlaps with part of the wireless area of a BLE AP 30.

FIG. 1B is a diagram for describing a second half of an overview of the connection control system 1 according to the embodiments. As illustrated in FIG. 1B, when a terminal 20 moves, the connection point WiFi AP 40 is switched automatically, thereby minimizing degradations in communication quality that have a risk of occurring when the connection with the prior WiFi AP 40 is maintained. Also, since the terminals 20 are unable to connect to the WiFi APs 40 from a common space such as a hallway, higher security advantages are obtained compared to the case in which any terminal 20 is able to connect as long as the SSID and PWD are known.

### Embodiment 1

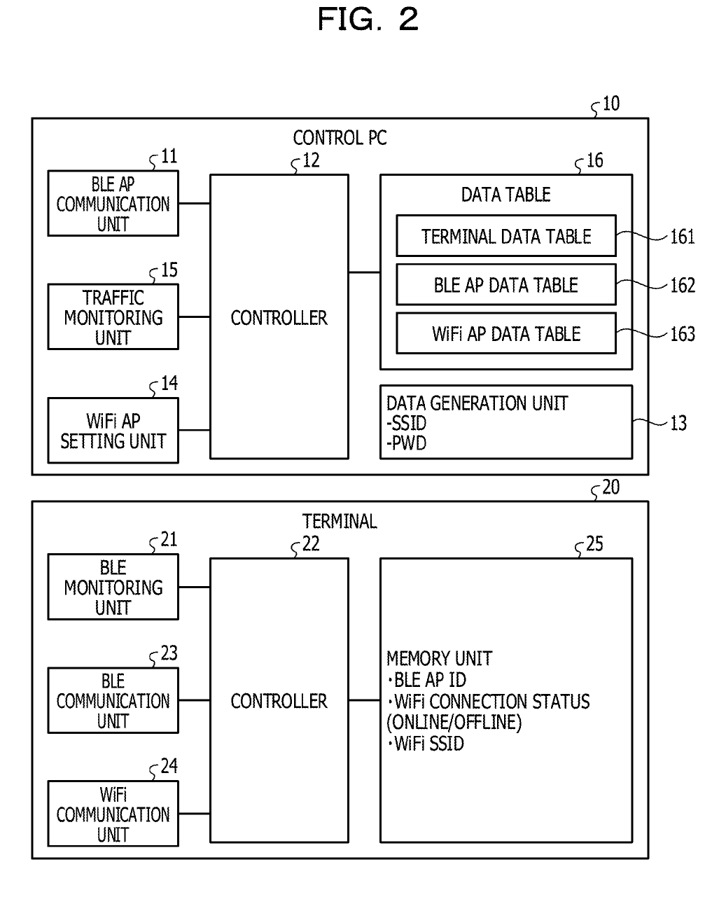

FIG. 2 is a diagram illustrating a functional configuration of the control PC 10 and the terminal 20 according to Embodiment 1. As illustrated in FIG. 2, the control PC 10 includes a BLE AP communication unit 11, a controller 12, a data generation unit 13, a WiFi AP setting unit 14, a traffic monitoring unit 15, and a data table 16. These component parts are connected in a manner enabling the input or output of signals and data, either unidirectionally or bidirectionally.

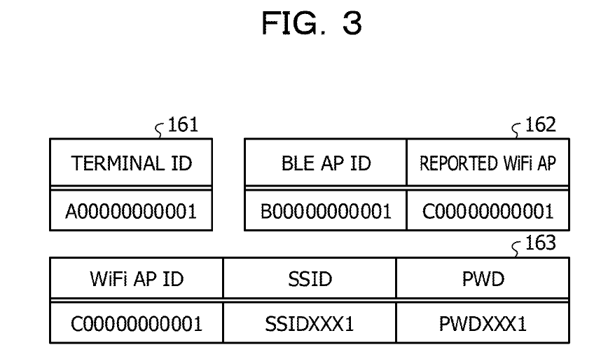

FIG. 3 is a diagram illustrating a data storage example in the data table 16 according to Embodiment 1. As illustrated in FIG. 3, the data table 16 further includes a terminal data table 161, a BLE AP data table 162, and a WiFi AP data table 163. In the terminal data table 161, as an ID of the terminal 20, “A00000000001” is stored, for example. Also, in the BLE AP data table 162, a WiFi AP (for example, C00000000001) is stored in association with a BLE AP ID (for example, B00000000001). Furthermore, in the WiFi AP data table 163, an SSID (for example, SSIDXXX1) and a PWD (for example, PWDXXX1) are stored in association with a WiFi AP ID (for example, C00000000001).

When data is received from a BLE AP 30, the BLE AP communication unit 11 transmits the terminal ID and the BLE AP ID to the controller 12. The controller 12 confirms whether or not the received terminal ID is registered in the data table 16, and if the received terminal ID is not registered, the controller 12 transmits a connection refusal. If the received terminal ID is registered, the controller 12 confirms the WiFi AP 40 designated in the BLE AP data table 162 with regard to the received BLE AP ID, and transmits the SSID and PWD regarding the WiFi AP 40 to the BLE AP communication unit 11. The BLE AP communication unit 11 may transmit configuration information that includes the SSID and PWD to the BLE AP 30.

The control PC 10 changes the SSID and PWD on a fixed cycle. The data generation unit 13 periodically generates and transmits the SSID and PWD regarding each WiFi AP 40 to the controller 12. The controller 12 updates the WiFi AP data table 163 based on the received SSID and PWD, and transmits the new SSID and PWD to the WiFi AP setting unit 14. The WiFi AP setting unit 14 may transmit the configuration information that includes the new SSID and PWD to each WiFi AP 40.

As illustrated in FIG. 2, the terminal 20 includes a BLE monitoring unit 21, a controller 22, a BLE communication unit 23, a WiFi communication unit 24, and a memory unit 25. These component parts are connected in a manner enabling the input or output of signals and data, either unidirectionally or bidirectionally.

When the terminal 20 receives a BLE advertise signal (hereinafter may be referred to as the “advertise signal”) from the BLE AP 30, the BLE monitoring unit 21 transmits the BLE AP ID and a received signal strength indication (RSSI) to the controller 22. The controller 22 stores the received BLE AP ID in the memory unit 25, and updates the BLE AP ID in the memory unit 25. The controller 22 references the memory unit 25, confirms the current WiFi connection status, and if the terminal 20 is already connected by WiFi (online), the controller 22 maintains the current status. If the terminal 20 is not connected by WiFi (offline), the controller 22 transmits a connection request to the BLE AP 30 via the BLE communication unit 23.

If connection is refused in response to the connection request to the BLE AP 30, the BLE communication unit 23 maintains the current status, and if the configuration information that includes an SSID and PWD are received from the BLE AP 30, the BLE communication unit 23 transmits the SSID and PWD included in the configuration information to the controller 22, and breaks the BLE connection. The controller 22 updates the WiFi connection status to “online” in the memory unit 25, while also storing the connection point SSID in the memory unit 25 and updating the WiFi SSID in the memory unit 25. The controller 22 transmits the above SSID and PWD to the WiFi communication unit 24. The WiFi communication unit 24 transmits the above SSID and PWD to the WiFi AP 40, and establishes a WiFi connection with the WiFi AP 40.

If the controller 22 detects that notifications from the BLE monitoring unit 21 have been cut off in accordance with the terminal 20 no longer receiving the advertise signal from the BLE AP 30, the controller 22 may reference a WiFi monitor, and confirms the current WiFi connection. If the result of the confirmation is that the terminal 20 is not connected with the WiFi AP 40, the controller 22 maintains the current status. If the terminal 20 is already connected with the WiFi AP 40, the controller 22 transmits an instruction for disconnection to the WiFi communication unit 24, and updates the WiFi connection status to “offline” in the memory unit 25. The WiFi communication unit 24 breaks the WiFi connection.

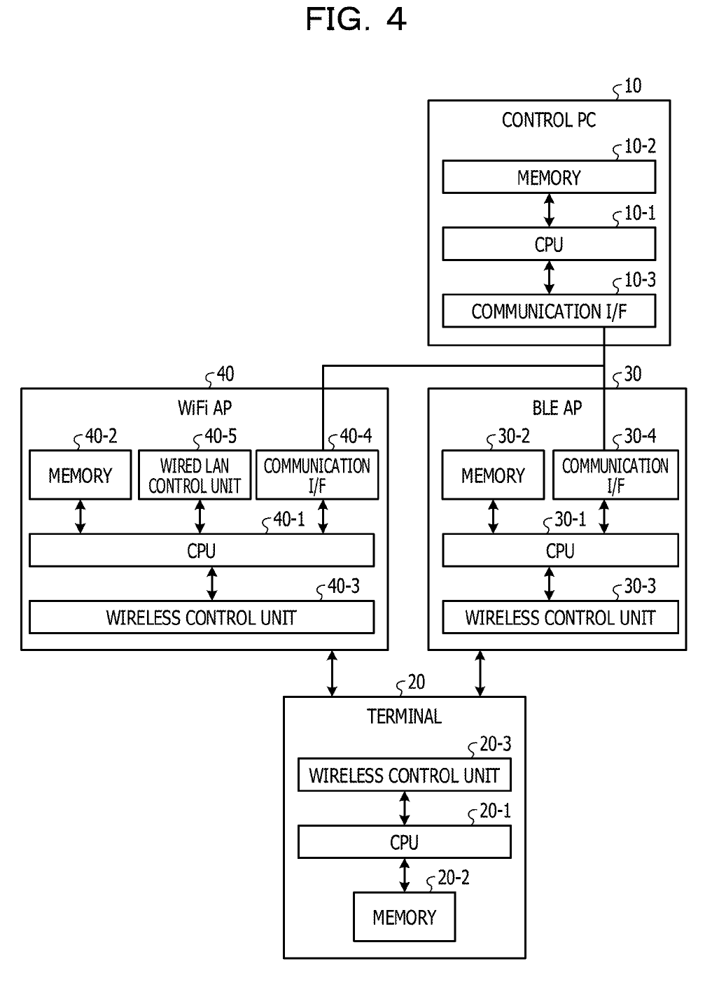

FIG. 4 is a diagram illustrating a hardware configuration of the connection control system 1 according to Embodiment 1. As illustrated in FIG. 4, the control PC 10 includes a central processing unit (CPU) 10-1, memory 10-2, and a communication interface (I/F) 10-3 as hardware components. The memory 10-2 is RAM such as synchronous dynamic random access memory (SDRAM), read-only memory (ROM), and flash memory, for example. Regarding the correspondence relationships between the functional configuration and the hardware configuration, among each of the functional components illustrated in FIG. 2, the components of the controller 12, the data generation unit 13, and the traffic monitoring unit 15 are realized by an integrated circuit such as the CPU 10-1, for example. Also, the data table 16 is realized by the memory 10-2. Furthermore, the BLE AP communication unit 11 and the WiFi AP setting unit 14 are realized by the communication I/F 10-3.

The terminal 20 is realized by a mobile terminal such as a mobile phone or a smartphone, for example. As illustrated in FIG. 4, in hardware terms, the terminal 20 includes a CPU 20-1, memory 20-2, and a wireless control unit 20-3. Regarding the correspondence relationships between the functional configuration and the hardware configuration, among each of the functional components illustrated in FIG. 2, the BLE monitoring unit 21 and the controller 22 are realized by an integrated circuit such as the CPU 20-1, for example. Also, the memory unit 25 is realized by the memory 20-2. Furthermore, the BLE communication unit 23 and the WiFi communication unit 24 are realized by the wireless control unit 20-3.

As illustrated in FIG. 4, in hardware terms, the BLE AP 30 includes a CPU 30-1, memory 30-2, a wireless control unit 30-3, and a communication I/F 30-4. Also, in hardware terms, the WiFi AP 40 includes a CPU 40-1, memory 40-2, a wireless control unit 40-3, a communication I/F 40-4, and a wired LAN control unit 40-5.

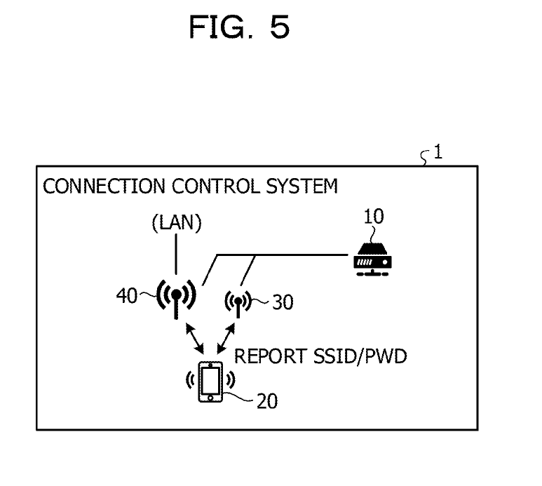

FIG. 5 is a diagram illustrating a configuration of the WiFi connection control system 1 according to Embodiment 1. As illustrated in FIG. 5, when the advertise signal is received from the BLE AP 30, the terminal 20 connects to the BLE AP 30. The BLE AP 30 transmits the ID of the connected terminal 20 to the control PC 10. The ID of the connected terminal 20 is an example of identification information transmitted from the terminal that is located within a range of the advertise signal from the BLE AP 30. If the terminal 20 having the above ID is a registered terminal, the control PC 10 transmits the configuration information that includes the SSID and PWD of a connection point to the terminal 20 through the BLE AP 30. The terminal 20 receives the configuration information that includes the above SSID and PWD, and connects with the WiFi AP 40 in accordance with the configuration information. The terminal 20 may release the connection with the BLE AP 30 after the configuration information is received from the BLE AP 30. Thereafter, the terminal 20 periodically measures the RSSI of the BLE AP 30, and disconnects from WiFi when the advertise signal from the BLE AP 30 is no longer received. The control PC 10 periodically changes the SSID and PWD that are set in the WiFi AP 40, and additionally changes the SSID and PWD to be transmitted to the terminal 20.

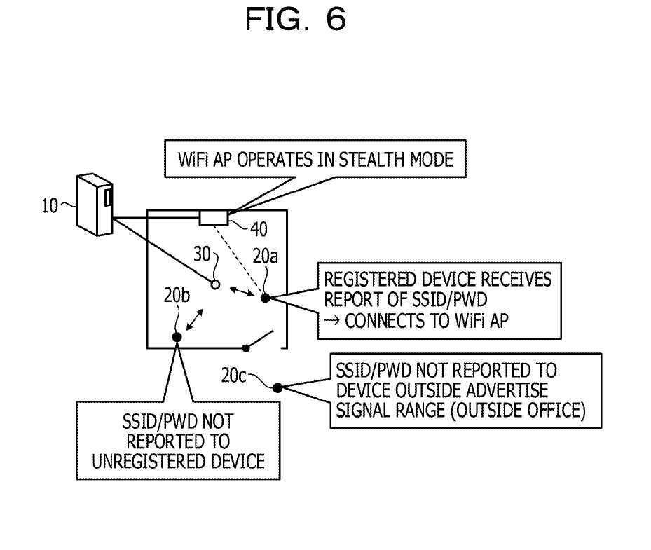

FIG. 6 is a diagram illustrating an example of application of the WiFi connection control system 1 according to Embodiment 1. As illustrated in FIG. 6, in the case in which the WiFi AP 40 is being operated in stealth mode, the SSID and PWD are transmitted to the terminal 20a which is a registered device, and the terminal 20a connects to the WiFi AP 40. The registered device is an example of a device that is allowed to access to the WiFi AP 40. In contrast, the SSID and PWD are not transmitted to the terminal 20b which is an unregistered device, and thus the terminal 20b does not connect to the WiFi AP 40. The unregistered device is an example of a device that is not allowed to access to the WiFi AP 40. Also, the terminal 20c, which is a device outside the office, is positioned beyond the range of the advertise signal. For this reason, the configuration information that includes the SSID and PWD are not transmitted to the terminal 20c, and the terminal 20c does not connect to the WiFi AP 40.

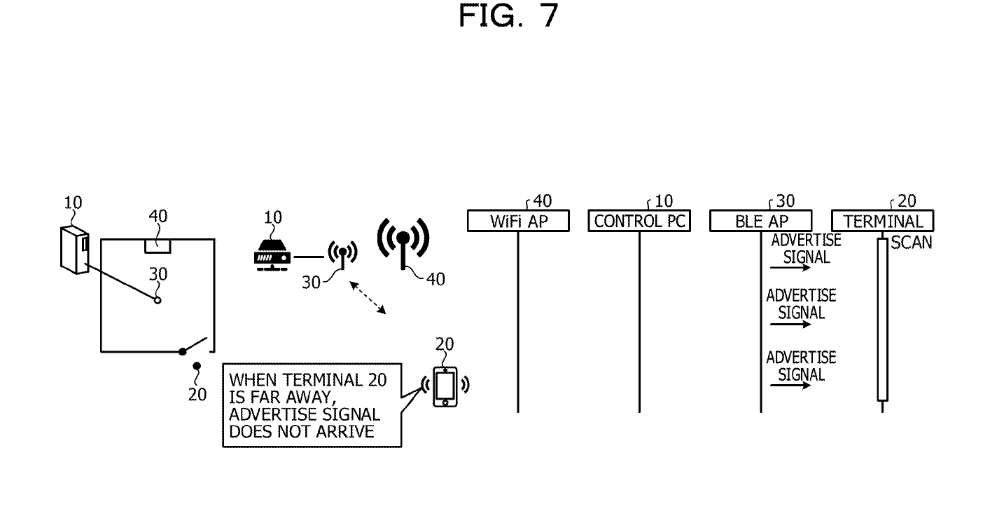

Next, operation will be described. FIG. 7 is a diagram for describing operation in Case 1-1 of the WiFi connection control system 1 according to Embodiment 1. As illustrated in FIG. 7, the BLE AP 30 broadcasts the advertise signal on a predetermined interval, while the terminal 20 scans. In the case in which the terminal 20 is distant from the BLE AP 30, the advertise signal does not arrive. For this reason, the terminal 20 does not connect to the WiFi AP 40.

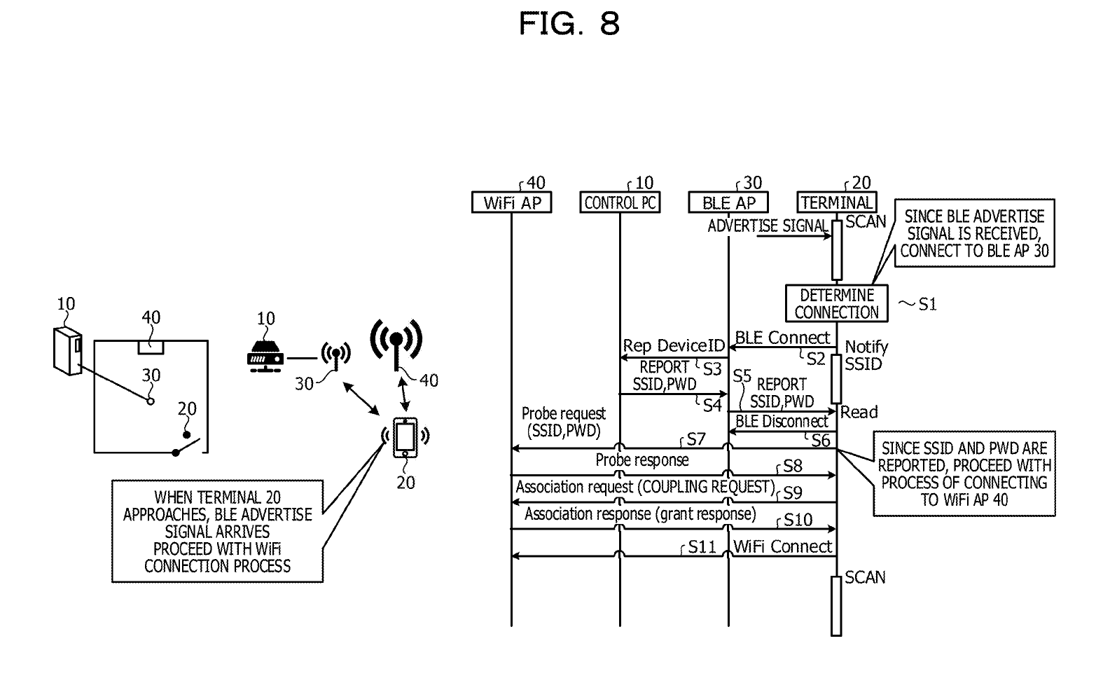

FIG. 8 is a diagram for describing operation in Case 1-2 of the WiFi connection control system 1 according to Embodiment 1. As illustrated in FIG. 8, when the terminal 20 approaches the BLE AP 30, the terminal 20 receives the advertise signal including the BLE AP ID, and determines that connection is possible (S1). In S2, the terminal 20 transmits BLE Connect including the terminal ID to the BLE AP 30. In S3, the BLE AP 30 transmits Rep DeviceID including the terminal ID and the BLE AP ID to the control PC 10. In S4 and S5, the control PC 10 transmits the SSID and PWD of the connection point WiFi AP 40 to the terminal 20 through the BLE AP 30. The terminal 20 receives the SSID and PWD, and then transmits BLE Disconnect to the BLE AP 30 (S6), and disconnects from the BLE AP 30.

The terminal 20 initiates a WiFi connection. Specifically, the terminal 20 transmits Probe request, which includes the above SSID and PWD as well as the terminal ID, to the WiFi AP 40 (S7), and thereby queries the WiFi AP 40 if the above SSID is the SSID set in the WiFi AP itself. If the SSID received from the terminal 20 matches the SSID set in the WiFi AP 40 itself, the WiFi AP 40 replies to the terminal 20 with Probe response, which includes the above SSID and PWD as well as the terminal ID (S8). In S9, the terminal 20 transmits Association request, which includes the above SSID and PWD as well as the terminal ID, to the WiFi AP 40, and thereby requests the WiFi AP 40 for a WiFi connection. In S10, the WiFi AP 40 replies to the terminal 20 with Association response, which includes the above SSID and PWD as well as the terminal ID, and thereby grants the terminal 20 a WiFi connection. With this arrangement, WiFi Connect is established between the terminal 20 and the WiFi AP 40 (S11).

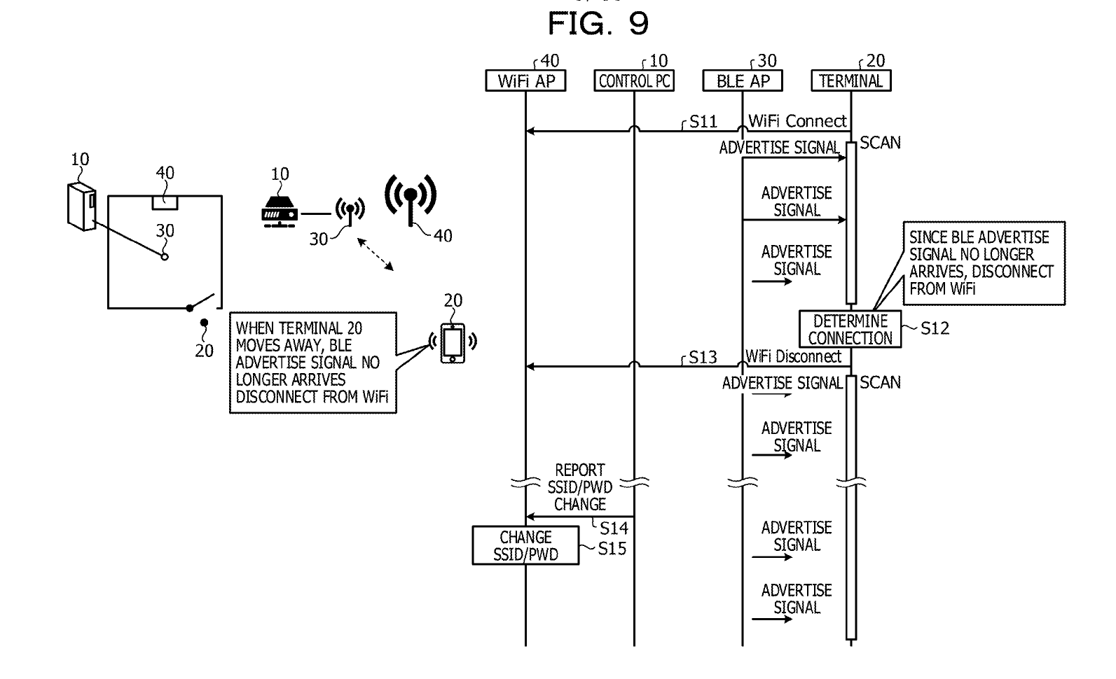

FIG. 9 is a diagram for describing operation in Case 1-3 of the WiFi connection control system 1 according to Embodiment 1. As illustrated in FIG. 9, even after the terminal 20 establishes a WiFi connection with the WiFi AP 40 (S11 described above), as long as the terminal 20 remains inside a predetermined area, the terminal 20 continues to receive the advertise signal from the BLE AP 30. However, if the terminal 20 goes outside the predetermined area, the reception of the advertise signal is cut off, and the terminal 20 determines that the prior WiFi connection is unavailable (S12). Consequently, the terminal 20 transmits WiFi Disconnect to the WiFi AP 40 (S13), and breaks the WiFi connection that had been established with the WiFi AP 40.

The control PC 10 periodically changes the SSID and PWD of the WiFi AP 40. Specifically, when the control PC 10 transmits an SSID/PWD change to the WiFi AP 40 (S14), the WiFi AP 40 changes the prior SSID and PWD to the new SSID and PWD (S15).

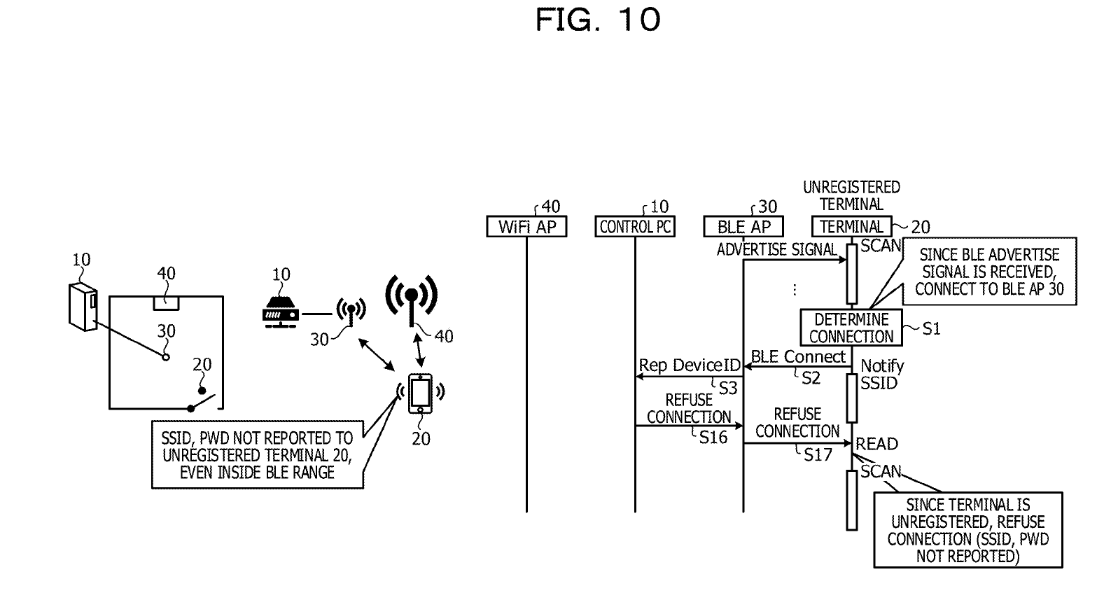

FIG. 10 is a diagram for describing operation in Case 1-4 of the WiFi connection control system 1 according to Embodiment 1. As illustrated in FIG. 10, since the processes from S1 to S3 of the first half are similar to the processes illustrated in FIG. 8, each process in S16 and S17 of the second half will be described. In the case in which the terminal 20 is a unregistered terminal in the control PC 10, even if the terminal 20 is within range to be able to receive the advertise signal, the SSID and PWD are not transmitted to the terminal 20. Instead, the control PC 10 transmits a WiFi connection refusal to the terminal 20 through the BLE AP 30 (S16, S17).

As described above, the control PC 10 includes the BLE AP communication unit 11 and the controller 12. The BLE AP communication unit 11 receives identification information regarding the terminal 20 that received, from the BLE AP 30, the advertise signal enabling connection to the WiFi AP 40. In the case in which the terminal 20 having the received identification information above is registered, the controller 12 transmits the SSID and PWD to the terminal 20 to notify the terminal 20 of the WiFi AP 40 that is to act as the connection point of the terminal 20. In the control PC 10, the controller 12 may periodically change the connection point information (SSID) and password (PWD) indicating the above connection point, and transmit the changed connection point information and password to the terminal 20.

In other words, for terminals receiving the BLE advertise signal, the control PC 10 determines whether to allow or deny connection to the WiFi AP 40, and transmits the connection point ID (SSID) to only the allowed terminals. With this arrangement, the control PC 10 causes only terminals near the WiFi AP 40 to connect to the WiFi AP 40, and thereby improves wireless LAN connection rate. That is, the control PC 10 detects the position of a person using the terminal 20 with BLE, and dynamically connects the terminal 20 to the WiFi AP 40 with the most favorable connectivity, thereby improving the connection rate of the system as a whole.

Consequently, the terminal 20 is able to appropriately change the connection point to a WiFi AP with favorable communication quality, and degraded communication quality due to maintaining the connection with the initially connected WiFi AP like in the past is minimized. Also, the terminal 20 is unable to connect to a desired WiFi AP unless the SSID and PWD of the connection point are received from the control PC 10. For this reason, risks such as malicious third parties eavesdropping or gaining unauthorized access by connecting from a common space such as a hallway like in the past are reduced. As a result, the security of the WiFi connection control system 1 is improved.

### Embodiment 2

Next, Embodiment 2 will be described. The connection control system according to Embodiment 2 has a configuration similar to the connection control system according to Embodiment 1 illustrated in FIGS. 2 and 4. Consequently, in Embodiment 2, components shared in common with Embodiment 1 will be denoted by the same reference signs, the illustration and detailed description of such components will be omitted, and the points that differ from Embodiment 1 will be described mainly.

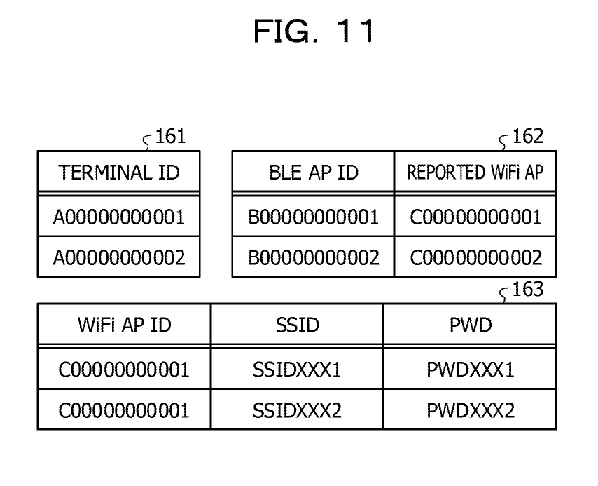

FIG. 11 is a diagram illustrating a data storage example in the data table 16 according to Embodiment 2. As illustrated in FIG. 11, the data table 16 further includes the terminal data table 161, the BLE AP data table 162, and the WiFi AP data table 163. In the terminal data table 161, as IDs of the terminals 20, “A00000000001” and “A00000000002” are stored, for example. Also, in the BLE AP data table 162, WiFi APs (for example, C00000000001, C00000000002) are stored in association with BLE AP IDs (for example, B00000000001, B00000000002). Furthermore, in the WiFi AP data table 163, SSIDs (for example, SSIDXXX1, SSIDXXX2) and PWDs (for example, PWDXXX1, PWDXXX2) are stored in association with WiFi AP IDs (for example, C00000000001, C00000000001).

When the terminal 20 receives the advertise signal from the BLE AP 30, the BLE monitoring unit 21 transmits multiple BLE AP IDs (for example, BLEAP1ID, BLEAP2ID) and multiple RSSIs (for example, RSSI1, RSSI2) to the controller 22. The controller 22 compares the multiple RSSIs, and in the case in which the BLE AP ID with the highest RSSI is the same as the BLE AP ID in the memory unit 25, the controller 22 maintains the current status. In the case in which the BLE AP ID with the highest RSSI is different, the controller 22 stores the BLE AP ID with the highest RSSI from among the received BLE AP IDs in the memory unit 25, and updates the BLE AP ID in the memory unit 25. Subsequently, the controller 22 transmits to the BLE communication unit 23 a connection request to connect to the BLE AP 30 with the highest RSSI.

If connection is refused in response to the connection request to the BLE AP 30, the BLE communication unit 23 maintains the current status, and if an SSID and PWD are transmitted, the BLE communication unit 23 transmits the SSID and PWD to the controller 22, and breaks the BLE connection. The controller 22 compares the received SSID to the WiFi SSID in the memory unit 25, and if these SSIDs are the same, the controller 22 maintains the current status. If the SSIDs are different, the controller 22 updates the WiFi connection status to “online” in the memory unit 25, while also storing the connection point SSID in the memory unit 25 and updating the WiFi SSID in the memory unit 25. The controller 22 transmits the above SSID and PWD to the WiFi communication unit 24. The WiFi communication unit 24 transmits the above SSID and PWD, and establishes a WiFi connection.

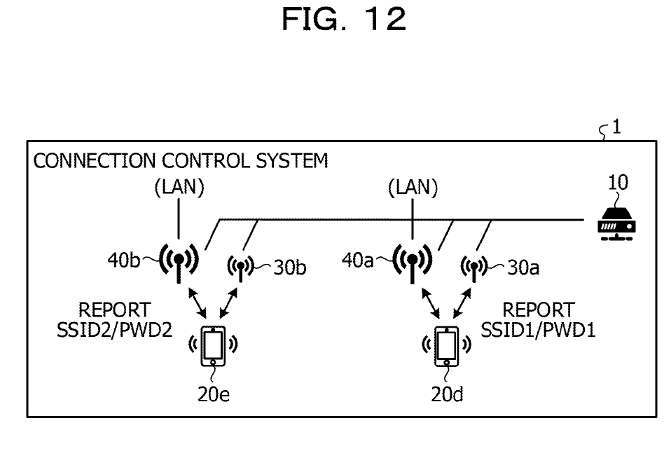

FIG. 12 is a diagram illustrating a configuration of the WiFi connection control system 1 according to Embodiment 2. As illustrated in FIG. 12, the terminals 20d and 20e respectively connect to the BLE APs 30a and 30b with the highest received signal strength. In association with the connection, the BLE APs 30a and 30b transmit the IDs of the connected terminals 20d and 20e to the control PC 10 in the higher-level system. The control PC 10 confirms whether or not each of the terminals 20d and 20e is a registered device, and if registered, the control PC 10 transmits the SSID and PWD of a connection point. The terminals 20d and 20e receive the SSID and PWD, and then break the BLE connection and switch to a WiFi connection. Thereafter, each of the terminals 20d and 20e periodically measures the RSSI of the BLE APs 30a and 30b, and in the case in which the BLE AP with the highest received signal strength changes, each of the terminals 20d and 20e breaks the current WiFi connection, and repeats execution of the processes described above.

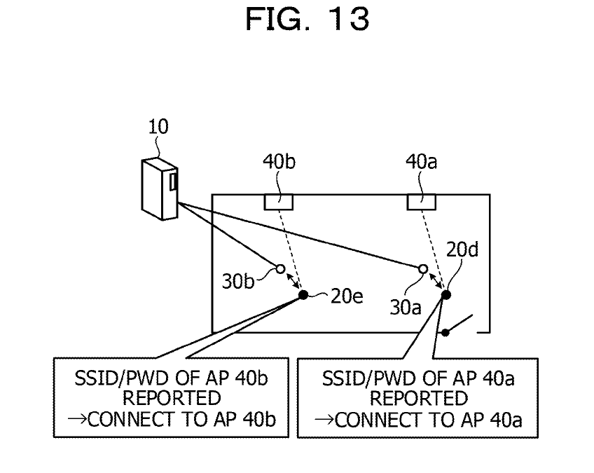

FIG. 13 is a diagram illustrating an example of application of the WiFi connection control system 1 according to Embodiment 2. As illustrated in FIG. 13, for the terminal 20d, the received signal strength of the BLE AP 30a is the highest, and for this reason the terminal 20d receives a transmit of the SSID and PWD of the WiFi AP 40a, and the terminal 20d connects to the WiFi AP 40a. On the other hand, for the terminal 20e, the received signal strength of the BLE AP 30b is the highest, and for this reason the terminal 20e receives a transmit of the SSID and PWD of the WiFi AP 40b, and the terminal 20e connects to the WiFi AP 40b. With this arrangement, each of the terminals 20d and 20e becomes able to connect to the WiFi AP positioned close to the terminal itself, and thus imbalances in the number of connected terminals among APs and radio wave interference from distant terminals are minimized.

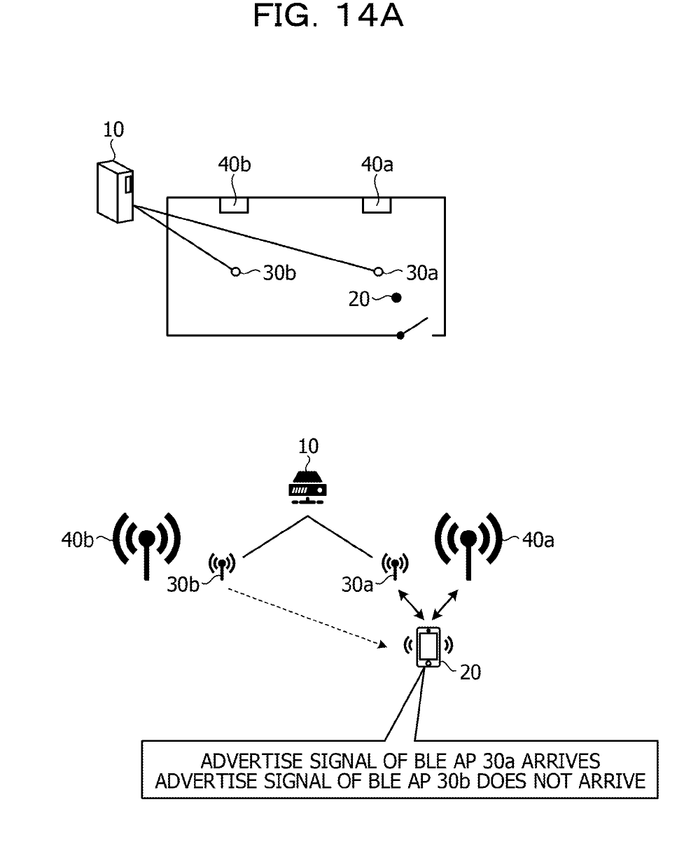

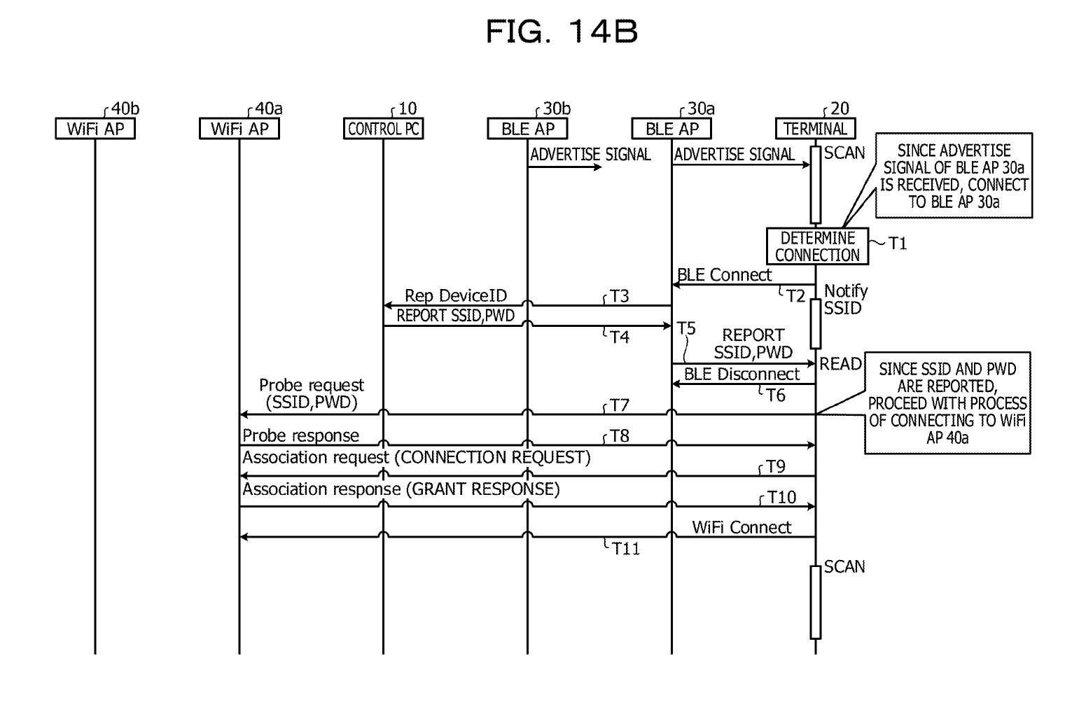

Next, operation will be described. FIG. 14A is a diagram for describing a first half of operation in Case 2-1 of the WiFi connection control system 1 according to Embodiment 2. FIG. 14B is a diagram for describing a second half of operation in Case 2-1 of the WiFi connection control system 1 according to Embodiment 2. FIG. 14B is similar to FIG. 8 referenced in the description of the operation according to Embodiment 1, except that the terminal 20 connects to the WiFi AP 40a corresponding to the BLE AP 30a from which the advertise signal arrives. Consequently, steps shared in common will be denoted by reference signs with the same suffix, and detailed description thereof will be omitted. Specifically, each process from steps T1 to T11 of FIG. 14B respectively corresponds to each process from step S1 to S11 illustrated in FIG. 8.

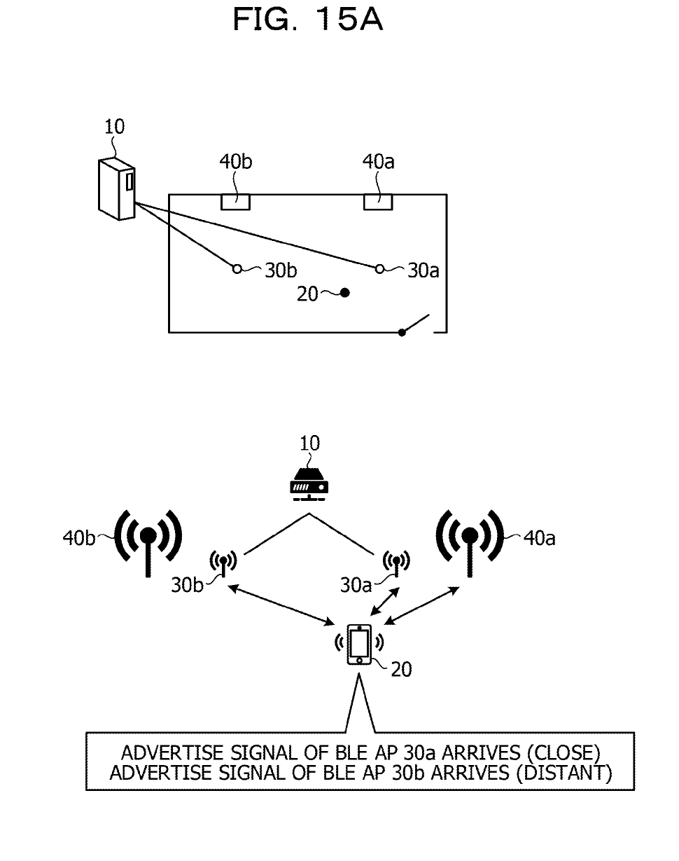

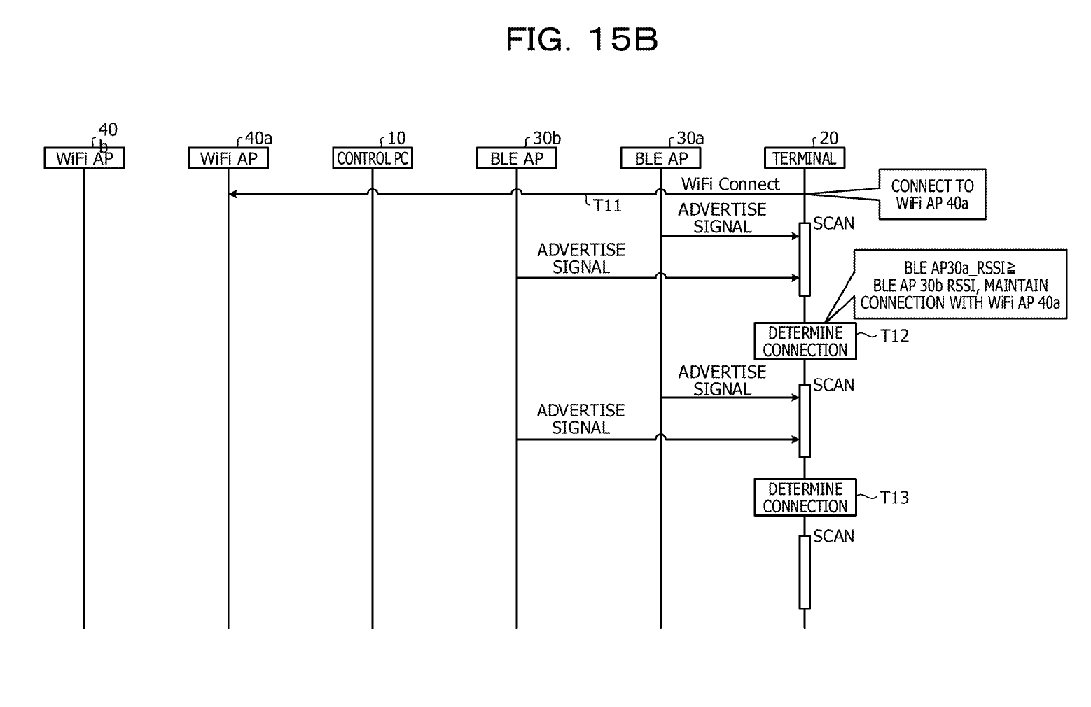

FIG. 15A is a diagram for describing a first half of operation in Case 2-2 of the WiFi connection control system 1 according to Embodiment 2. FIG. 15B is a diagram for describing a second half of operation in Case 2-2 of the WiFi connection control system 1 according to Embodiment 2. As illustrated in FIGS. 15A and 15B, even after the terminal 20 has established a WiFi connection with the WiFi AP 40a (T11 described above), the terminal 20 maintains the connection with the WiFi AP 40a on the BLE AP 30a side as long as (RSSI of BLE AP 30a RSSI of BLE AP 30b) holds true. Thereafter, while (RSSI of BLE AP 30a RSSI of BLE AP 30b) holds true, the terminal 20 continues the WiFi connection with the WiFi AP 40a on the side of the BLE AP 30a with the high RSSI.

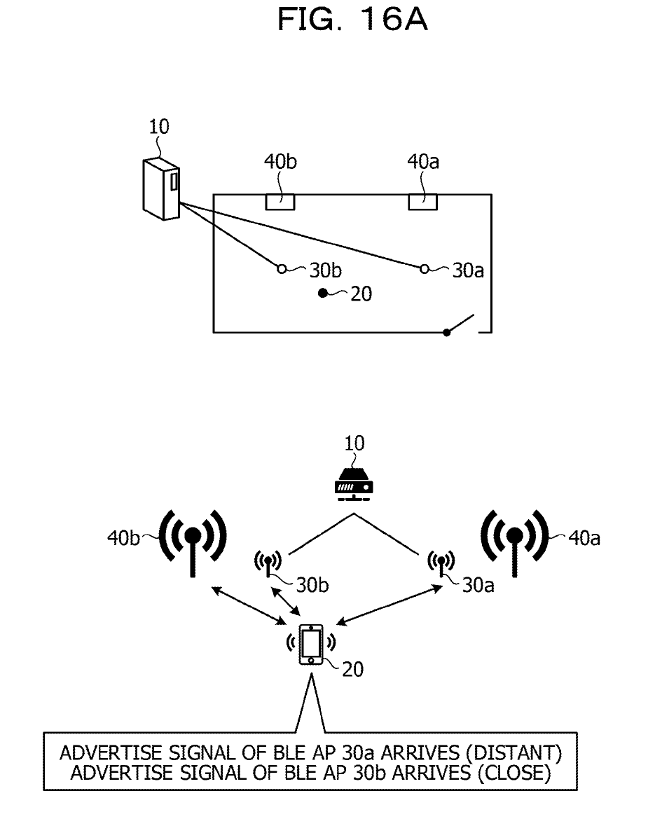

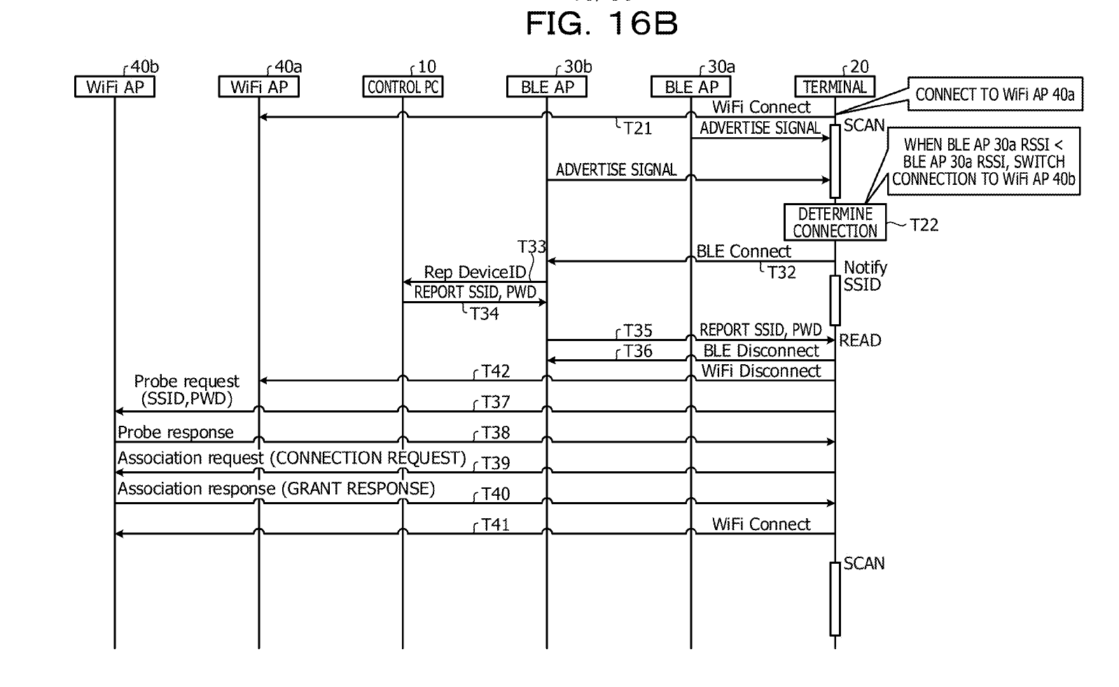

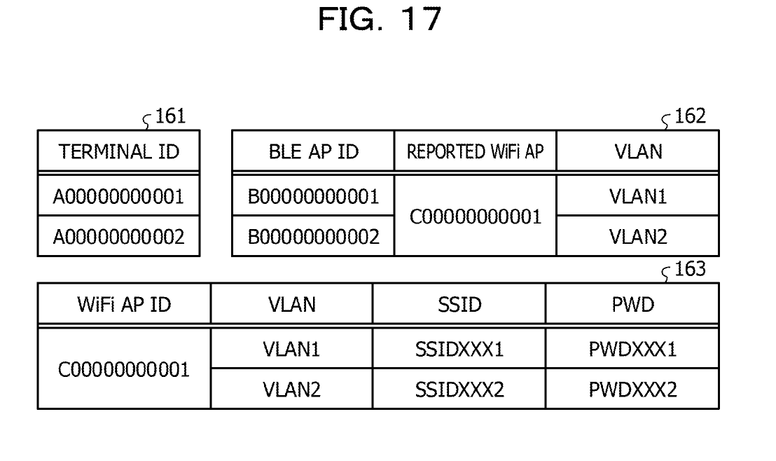

FIG. 16A is a diagram for describing a first half of operation in Case 2-3 of the WiFi connection control system 1 according to Embodiment 2. FIG. 16B is a diagram for describing a second half of operation in Case 2-3 of the WiFi connection control system 1 according to Embodiment 2. FIG. 16B is similar to FIGS. 14B and 15B referenced in the description of the operation according to Embodiment 2, except for T42. Consequently, steps shared in common will be denoted by reference signs with the same suffix, and detailed description thereof will be omitted. Specifically, each process in steps T21 and T22 of FIG. 16B respectively corresponds to each process in steps T11 and T12 illustrated in FIG. 15B, and each process in steps T32 to T41 of FIG. 16B respectively corresponds to each process in steps T2 to T11 illustrated in FIG. 14B. However, in the disconnection of T22, as illustrated in FIG. 16A, (RSSI of BLE AP 30a<RSSI of BLE AP 30b) holds true. For this reason, the terminal 20 transmits WiFi Disconnect to the prior connection point, namely the WiFi AP 40a (T42), thereby disconnecting from the WiFi AP 40a, and establishes a new connection with the WiFi AP 40b on the BLE AP 30b side.

As described above, in the WiFi connection control system 1 according to Embodiment 2, the terminal 20 connects to the BLE AP 30a with the highest received signal strength from among the BLE APs 30a and 30b, and receives the above signal from the BLE AP 30a. In the case in which the BLE AP with the high received signal strength changes to the BLE AP 30b, the terminal 20 breaks the current connection with the WiFi AP 40a, and transmits identification information about the terminal 20 itself to the BLE AP 30b. According to the WiFi connection control system 1 according to Embodiment 2, the control PC 10 is able to select an optimal WiFi AP from among multiple installed WiFi APs 40 based on BLE AP position information, and cause a terminal to connect to the selected WiFi AP.

### Embodiment 3

Next, Embodiment 3 will be described. The connection control system according to Embodiment 3 has a configuration similar to the connection control system according to Embodiment 1 illustrated in FIGS. 2 and 4. Consequently, in Embodiment 3, components shared with Embodiment 1 will be denoted by the same reference signs, the illustration and detailed description of such components will be omitted, and the points that differ from Embodiment 1 will be described mainly.

FIG. 17 is a diagram illustrating a data storage example in the data table 16 according to Embodiment 3. As illustrated in FIG. 17, the data table 16 further includes the terminal data table 161, the BLE AP data table 162, and the WiFi AP data table 163. In the terminal data table 161, as IDs of the terminals 20, “A00000000001” and “A00000000002” are stored, for example. Also, in the BLE AP data table 162, WiFi APs (for example, C00000000001, C00000000002) and virtual LANs (VLANs; for example, VLAN1, VLAN2) are stored in association with BLE AP IDs (for example, B00000000001, B00000000002). Furthermore, in the WiFi AP data table 163, VLANs (for example, VLAN1, VLAN2), SSIDs (for example, SSIDXXX1, SSIDXXX2), and PWDs (for example, PWDXXX1, PWDXXX2) are stored in association with a WiFi AP ID (for example, C00000000001).

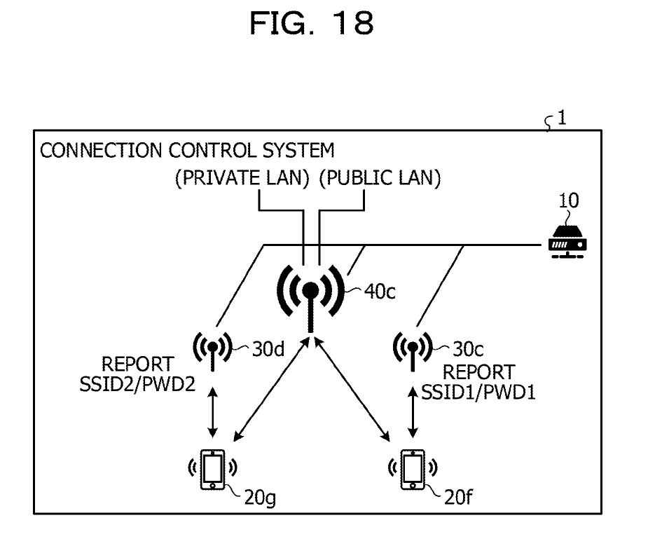

FIG. 18 is a diagram illustrating a configuration of the WiFi connection control system 1 according to Embodiment 3. As illustrated in FIG. 18, each of the user devices, namely each of the terminals 20f and 20g, connects to the BLE APs 30c and 30d with the highest received signal strength, similarly to Embodiment 2, and receives a different SSID and PWD. In other words, the control PC 10 transmits an appropriate SSID and PWD in accordance with the conditions through the BLE APs 30c and 30d. For example, for meetings with clients, the control PC 10 transmits an SSID and PWD (SSID1/PWD1) that function as a public LAN, while for internal company meetings, the control PC 10 transmits an SSID and PWD (SSID2/PWD2) that function as the company's private LAN. The terminals 20f and 20g receive the above SSID and PWD, and then break the BLE connection and switch to a WiFi connection.

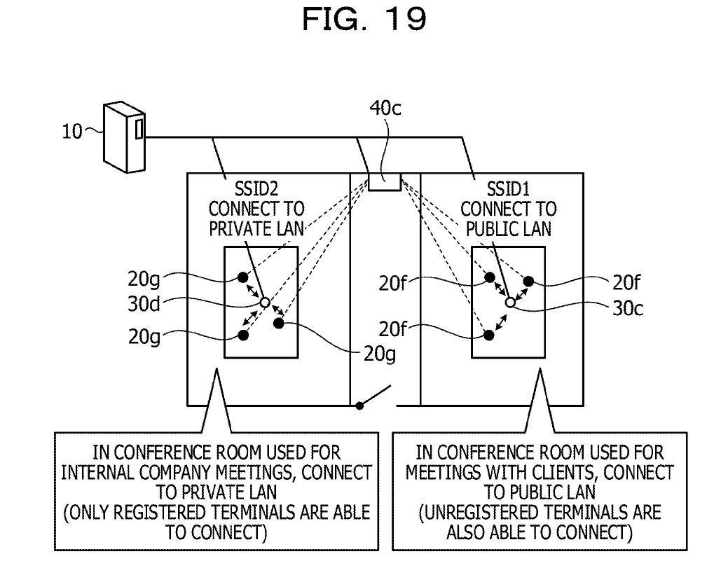

FIG. 19 is a diagram illustrating an example of application of the WiFi connection control system 1 according to Embodiment 3. As illustrated in FIG. 19, the control PC 10 enables even unregistered terminals to connect to a public LAN, and enables only registered terminals to connect to the company's private LAN. With this arrangement, it becomes possible to use different configurations for different situations, such as granting users the usage of only the public LAN in a conference room used for meetings with clients, and granting users usage of only the company's private LAN in a conference room used for internal company meetings.

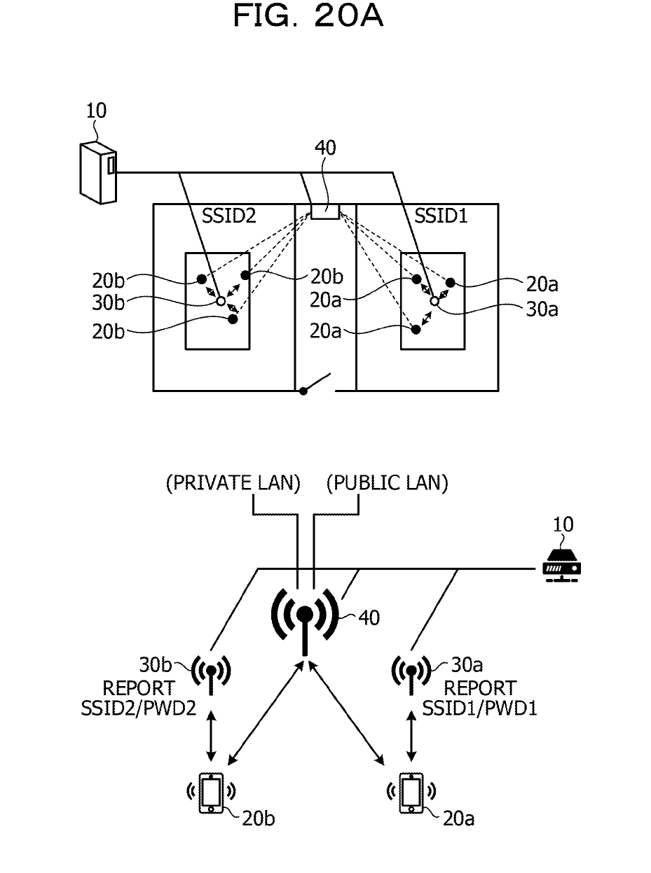

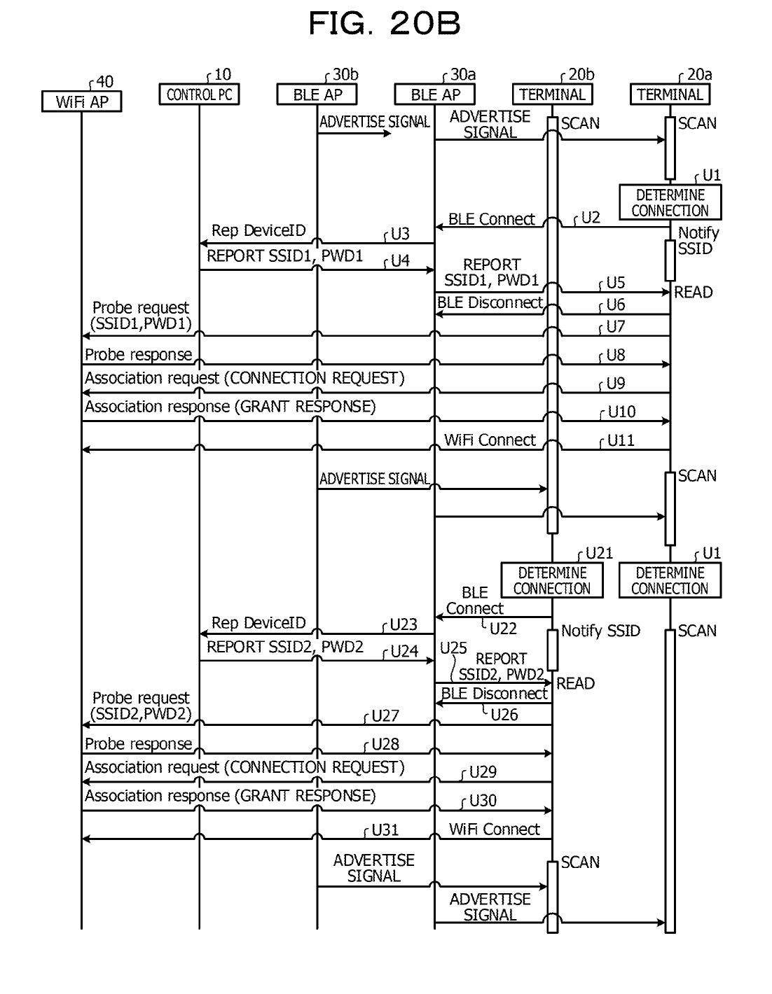

Next, operation will be described. FIG. 20A is a diagram for describing a first half of operation in Case 3-1 of the WiFi connection control system 1 according to Embodiment 3. FIG. 20B is a diagram for describing a second half of operation in Case 3-1 of the WiFi connection control system 1 according to Embodiment 3. FIG. 20B is similar to FIG. 8 referenced in the description of operation according to Embodiment 1, except that the single WiFi AP 40 has multiple SSIDs. Consequently, steps shared in common will be denoted by reference signs with the same suffix, and detailed description thereof will be omitted. Specifically, each process from steps U1 to U11 of FIG. 20B respectively corresponds to each process from steps S1 to S11 illustrated in FIG. 8. Also, each process from steps U21 to U31 of FIG. 20B respectively corresponds to each process from steps S1 to S11 illustrated in FIG. 8.

As described above, in the WiFi connection control system 1 according to Embodiment 3, the controller 12 of the control PC 10 transmits different WiFi APs 40 (for example, SSID1, SSID2) to the terminals 20 through the BLE APs 30c and 30d, in accordance with the users of the terminals 20. For example, the control PC 10 becomes able to control connections depending on the LAN usage conditions, such as by designating the WiFi AP (for example, SSID1) of a public LAN (for example, VLAN1) as the connection point for meetings with clients, and designating the WiFi AP (for example, SSID2) of the company's private LAN (for example, VLAN2) as the connection point for internal company meetings. Also, the control PC 10 switches the SSID and PWD of the connection point in accordance with the terminal user, and thus security when using wireless LAN is improved.

### Embodiment 4

Next, Embodiment 4 will be described. The connection control system according to Embodiment 4 has a configuration similar to the connection control system according to Embodiment 1 illustrated in FIGS. 2 and 4. Consequently, in Embodiment 4, components shared in common with Embodiment 1 will be denoted by the same reference signs, the illustration and detailed description of such components will be omitted, and the points that differ from Embodiment 1 will be described mainly.

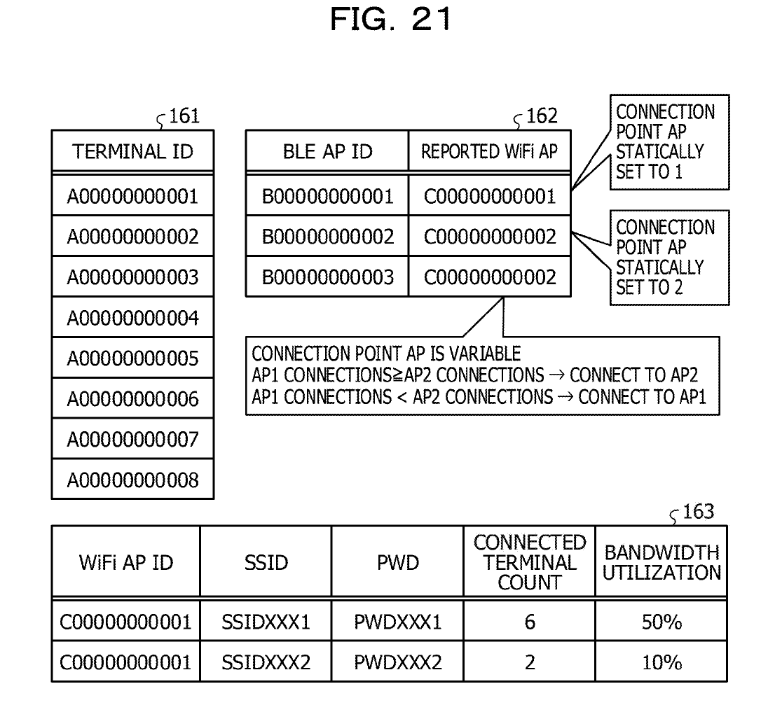

FIG. 21 is a diagram illustrating a data storage example in the data table 16 according to Embodiment 4. As illustrated in FIG. 21, the data table 16 further includes the terminal data table 161, the BLE AP data table 162, and the WiFi AP data table 163. In the terminal data table 161, as IDs of the terminals 20, “A00000000001” to “A00000000008” are stored, for example. Also, in the BLE AP data table 162, WiFi APs (for example, C00000000001, C00000000002, C00000000002) are stored in association with BLE AP IDs (for example, B00000000001, B00000000002, B00000000003). Furthermore, in the WiFi AP data table 163, SSIDs (for example, SSIDXXX1, SSIDXXX2), PWDs (for example, PWDXXX1, PWDXXX2), connected terminal counts (for example, 6, 2), and bandwidth utilizations (for example, 50%, 10%) are stored in association with a WiFi AP ID (for example, C00000000001).

Referring to the BLE AP data table 162, in the case in which the BLE AP ID is B00000000001, the connection point WiFi AP is statically set to the WiFi AP with the ID C00000000001. In the case in which the BLE AP ID is B00000000002, the connection point WiFi AP is statically set to the WiFi AP with the ID C00000000002. In contrast, in the case in which the BLE AP ID is B00000000003, the connection point WiFi AP is made to be variable. For example, in the case in which the connected terminal count of the WiFi AP with the ID C00000000001 is equal to or greater than to the connected terminal count of the WiFi AP having the ID C00000000002, the terminal having the BLE AP ID of B00000000003 is connected to the latter WiFi AP. Also, in the case in which the connected terminal count of the WiFi AP with the ID C00000000001 is less than the connected terminal count of the WiFi AP with the ID C00000000002, the terminal having the BLE AP ID of B00000000003 is connected to the former WiFi AP. Note that bandwidth utilization may be used instead of the connected terminal count. With this arrangement, it becomes possible to control connections with little bias in utilized resources.

When the control PC 10 receives traffic information (for example, the connected terminal count and the bandwidth utilization), the traffic monitoring unit 15 transmits the connected terminal count and the bandwidth utilization of each WiFi AP 40 to the controller 12. The controller 12 uses the above connected terminal count and bandwidth utilization to update the WiFi AP data table 163. The controller 12 updates the WiFi AP 40 to transmit to the BLE AP 30, based on the connected terminal count and the bandwidth utilization of the WiFi AP 40.

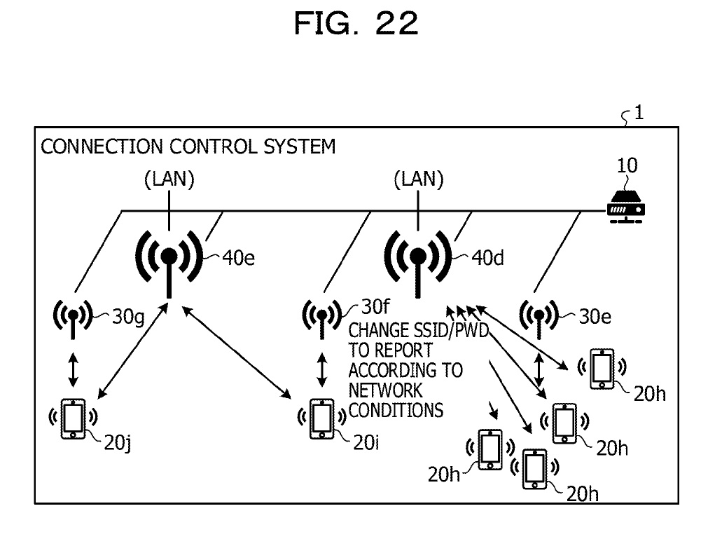

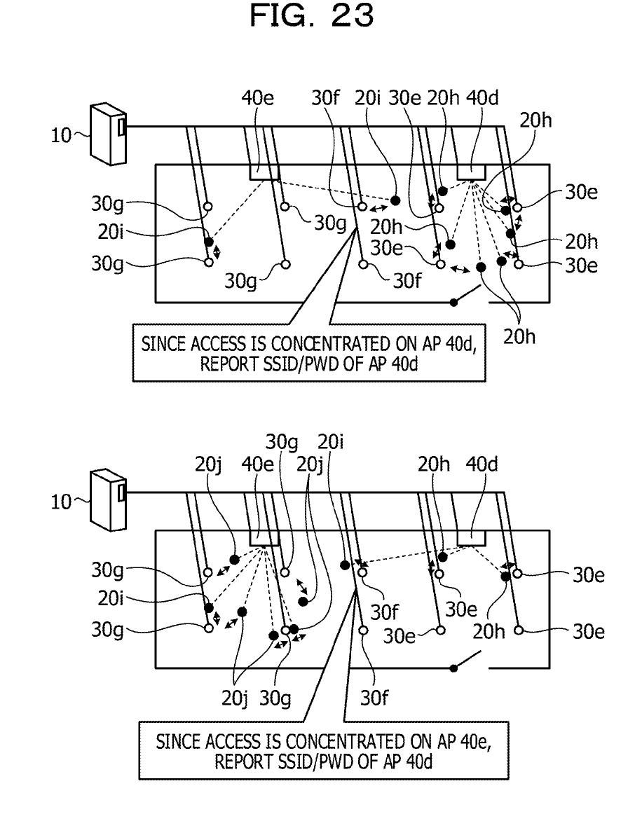

FIG. 22 is a diagram illustrating a configuration of the WiFi connection control system 1 according to Embodiment 4. As illustrated in FIG. 22, each of the user devices, namely each of the terminals 20h to 20m, connects to the BLE APs 30e to 30g with the highest received signal strength from the perspective of the terminal itself, similarly to Embodiments 2 and 3, and receives a different SSID and PWD depending on the network conditions. In other words, the control PC 10 transmits optimal SSIDs and PWDs in accordance with the conditions of the network as a whole through the BLE APs 30e to 30g. For example, in the case in which access is concentrated on the WiFi AP 40d, the control PC 10 causes the terminal 20l near the middle point between the WiFi APs 40d and 40e to connect to the WiFi AP 40e. The terminals 20h to 20m receive the above SSIDs and PWDs, and then break the BLE connection and switch to a WiFi connection.

FIG. 23 is a diagram illustrating an example of application of the WiFi connection control system 1 according to Embodiment 4. As illustrated in FIG. 23, in the case in which access from the terminal 20h is concentrated on the WiFi AP 40d, the sensor 10 transmits the SSID and PWD of the WiFi AP 40e as the connection point to the terminal 20i positioned in the middle. In contrast, in the case in which access from the terminal 20j is concentrated on the WiFi AP 40e, the control PC 10 transmits the SSID and PWD of the WiFi AP 40d as the connection point to the terminal 20i positioned in the middle. With this arrangement, each of the terminals 20h, 20i, and 20j is connected to an optimal WiFi AP appropriate to the access conditions of the network as a whole. Consequently, the network load on the WiFi APs 40d and 40e is distributed. As a result, it is possible to minimize degradations in communication quality.

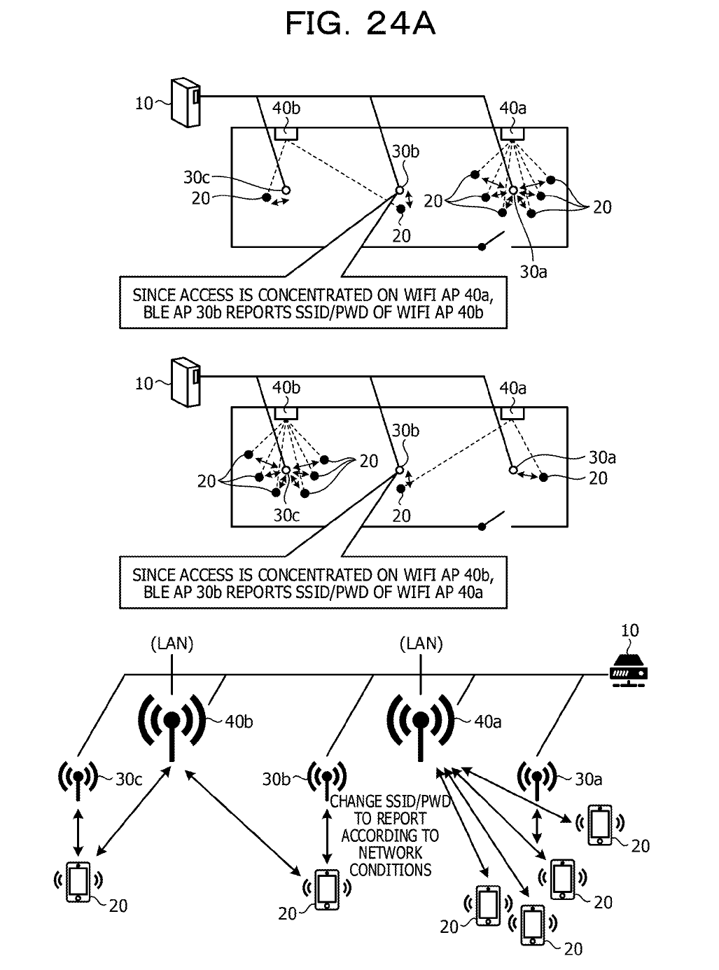

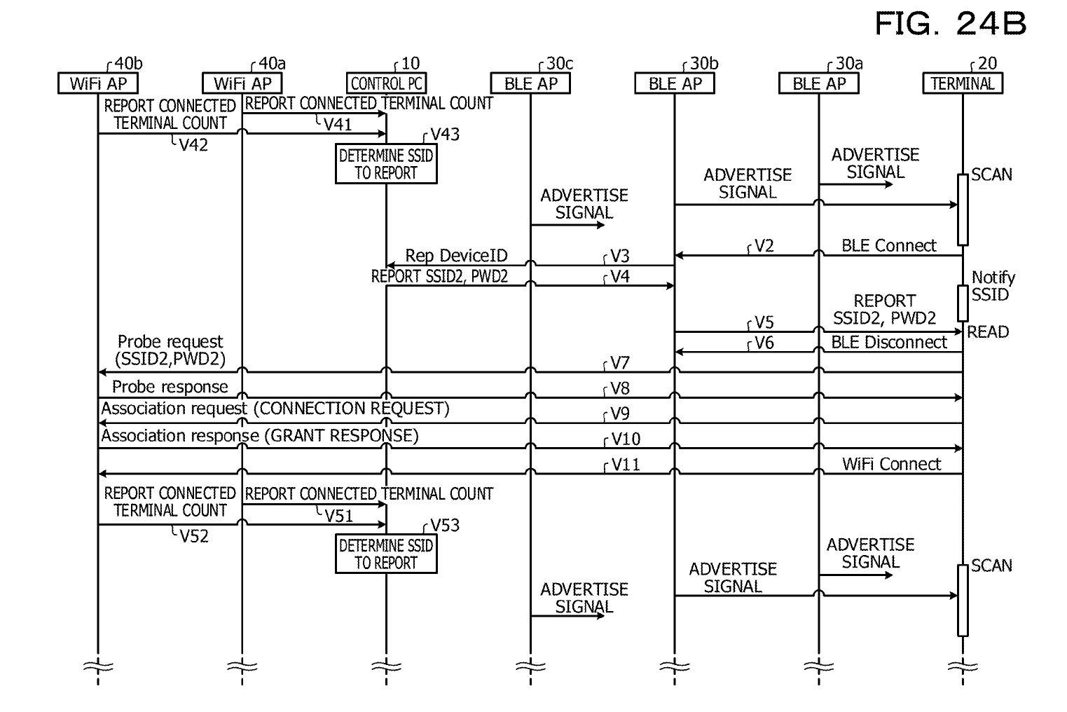

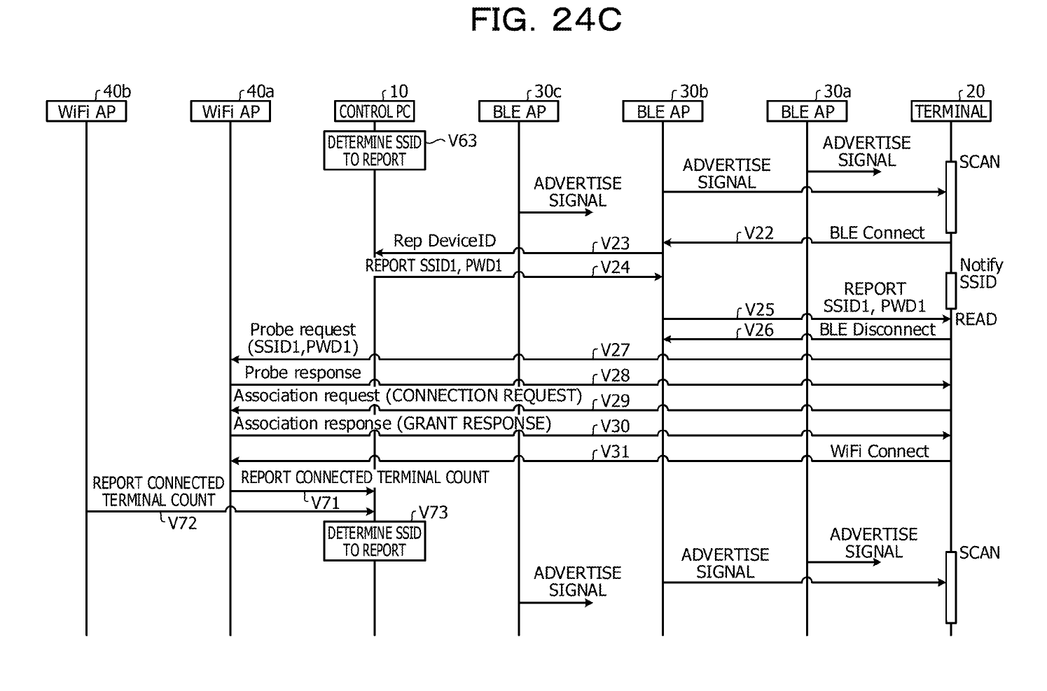

Next, operation will be described. FIG. 24A is a diagram for describing a first part of operation in Case 4-1 of the WiFi connection control system 1 according to Embodiment 4. FIG. 24B is a diagram for describing a second part of operation in Case 4-1 of the WiFi connection control system 1 according to Embodiment 4. FIG. 24C is a diagram for describing a third part of operation in Case 4-1 of the WiFi connection control system 1 according to Embodiment 4. FIGS. 24B and 24C are similar to FIG. 20B referenced in the description of operation according to Embodiment 3, except that the WiFi AP 40 of the connection point is changed to distribute the access load. Consequently, steps shared in common will be denoted by reference signs with the same suffix, and detailed description thereof will be omitted. Specifically, each process from steps V2 to V11 of FIG. 24A respectively corresponds to each process from steps U2 to U11 illustrated in FIG. 20B. Also, each process from steps V22 to V31 of FIG. 24B respectively corresponds to each process from steps U22 to U31 illustrated in FIG. 20B.

In V41, the control PC 10 receives a transmit of the connected terminal count at the current time from the WiFi AP 40a. Similarly, in V42, the control PC 10 receives a transmit of the connected terminal count at the current time from the WiFi AP 40b. As illustrated in FIG. 24A, since the connected terminal count of the WiFi AP 40a is greater than the connected terminal count of the WiFi AP 40b, the control PC 10 transmits the SSID of the WiFi AP 40b with the smaller connected terminal count as the connection point to the terminal 20 in the middle that connects to the BLE AP 30b (V43). Note that the SSID of the WiFi AP 40a is transmitted to the terminal 20 that connects to the BLE AP 30a, and the SSID of the WiFi AP 40b is transmitted to the terminal 20 that connects to the BLE AP 30c.

At the time of V63, unlike the time of V43, the connected terminal count of the WiFi AP 40b overtakes the connected terminal count of the WiFi AP 40a, and (connected terminal count of WiFi AP 40b>connected terminal count of WiFi AP 40a) holds true. Consequently, the control PC 10 preferentially transmits the SSID of the WiFi AP 40a with the smaller connected terminal count as the connection point to the terminal 20 in the middle that connects to the BLE AP 30b (V63). Note that each process from V51 to V53 and V71 to V73 is similar to each process from V41 to V43, and thus is denoted by a reference sign with the same suffix, and detailed description thereof will be omitted.

In Embodiment 4, the case in which there are two WiFi APs 40 is illustrated as an example, but there may also be three or more WiFi APs 40. In this case, the SSID of the WiFi AP 40 with the smallest connected terminal count is preferentially transmitted, but the control PC 10 is not limited to the connected terminal count, and may also perform weighting in accordance with other network conditions (such as the bandwidth utilization, the amount of communicated data, or drops in communication speed, for example). For example, even if the WiFi AP 40a exceeds the WiFi AP 40b in connected terminal count, but still falls below in any of the bandwidth utilization, the amount of communicated data, or drops in communication speed, the control PC 10 may preferentially transmit the SSID of the WiFi AP 40a. With this arrangement, load distribution that better conforms to the actual circumstances of the network becomes possible. Alternatively, the control PC 10 is not limited to network conditions, and may also preferentially transmit the SSID of the WiFi AP 40 positioned closest to the terminal 20, in accordance with the arrangement of each WiFi AP 40.

As described above, in the WiFi connection control system 1 according to Embodiment 3, the controller 12 of the control PC 10 transmits a different WiFi AP to the terminal 20 through the BLE APs 30e to 30g in accordance with the network conditions (such as the connected terminal count of terminals connected to each WiFi AP, the bandwidth utilization, the amount of communicated data, or drops in communication speed, for example). With this arrangement, the network load is distributed, and it is possible to minimize degradations in communication quality.

### Embodiment 5

Next, Embodiment 5 will be described. The connection control system according to Embodiment 5 has a configuration similar to the connection control system according to Embodiment 1 illustrated in FIGS. 2 and 4. Consequently, in Embodiment 5, components shared in common with Embodiment 1 will be denoted by the same reference signs, the illustration and detailed description of such components will be omitted, and the points that differ from Embodiment 1 will be described mainly.

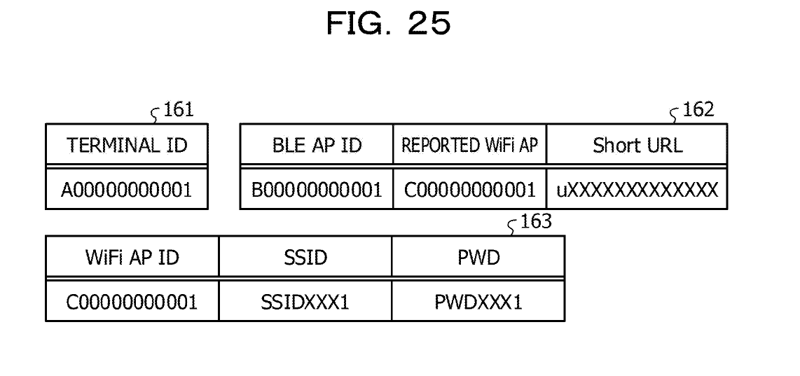

FIG. 25 is a diagram illustrating a data storage example in the data table 16 according to Embodiment 5. As illustrated in FIG. 25, the data table 16 further includes the terminal data table 161, the BLE AP data table 162, and the WiFi AP data table 163. In the terminal data table 161, as an ID of the terminal 20, “A00000000001” is stored, for example. Also, in the BLE AP data table 162, a WiFi AP (for example, C00000000001) and a Short Uniform Resource Locator (Short URL; for example, L00000000000000 is stored in association with a BLE AP ID (for example, B00000000001). Furthermore, in the WiFi AP data table 163, an SSID (for example, SSIDXXX1) and PWD (for example, PWDXXX1) are stored in association with a WiFi AP ID (for example, C00000000001).

When the control PC 10 receives data from the BLE AP 30, the BLE AP communication unit 11 transmits the terminal ID and the BLE AP ID to the controller 12. The controller 12 confirms whether or not the received terminal ID is registered in the terminal data table 161, and if the received terminal ID is not registered, the controller 12 transmits a connection refusal. If the received terminal ID is registered, the controller 12 confirms the WiFi AP 40 and Short URL designated in the BLE AP data table 162 with regard to the received BLE AP ID, and transmits the SSID, PWD, and Short URL of the WiFi AP 40 to the BLE AP communication unit 11. The BLE AP communication unit 11 transmits the SSID, PWD, and Short URL to the BLE AP 30.

When the terminal 20 receives the advertise signal from the BLE AP 30, the BLE monitoring unit 21 transmits the BLE AP ID and the RSSI to the controller 22. The controller 22 stores the received BLE AP ID in the memory unit 25, and updates the BLE AP ID in the memory unit 25. The controller 22 references the memory unit 25, confirms the current WiFi connection status, and if the terminal 20 is already connected by WiFi (online), the controller 22 maintains the current status. If the terminal 20 is not connected by WiFi (offline), the controller 22 transmits to the BLE communication unit 23 a connection request to the BLE AP 30.

If connection is refused in response to the connection request to the BLE AP 30, the BLE communication unit 23 maintains the current status, and if an SSID, PWD, and Short URL are transmitted, the BLE communication unit 23 transmits the SSID, PWD, and Short URL to the controller 22, and breaks the BLE connection. The controller 22 updates the WiFi connection status to “online” in the memory unit 25, while also storing the connection point SSID in the memory unit 25 and updating the WiFi SSID in the memory unit 25. The controller 22 transmits the above SSID, PWD, and Short URL to the WiFi communication unit 24. The WiFi communication unit 24 transmits the above SSID and PWD, and establishes a WiFi connection. Subsequently, the WiFi communication unit 24 connects to the designated Short URL, and starts receiving data.

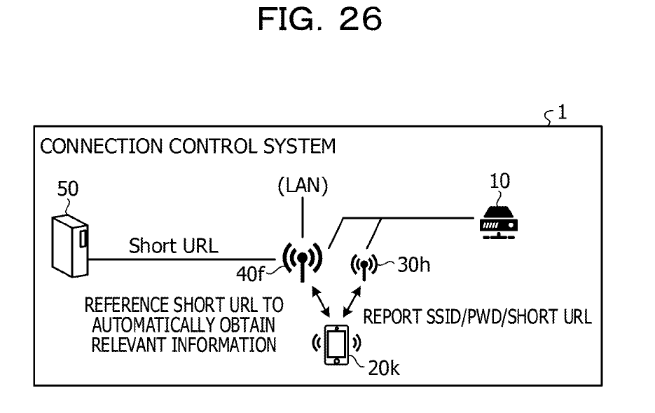

FIG. 26 is a diagram illustrating a configuration of the WiFi connection control system 1 according to Embodiment 5. As illustrated in FIG. 26, a user device, namely the terminal 20k, connects to the BLE AP 30h with the highest received signal strength. In association with the connection, the BLE AP 30h transmits the ID of the connected terminal 20k to the control PC 10 in the higher-level system. The control PC 10 confirms whether or not the terminal 20k is a registered device, and if registered, the control PC 10 transmits the SSID and PWD as well as the Short URL of a connection point. The terminal 20k receives the SSID, PWD, and Short URL, and then breaks the BLE connection and switches to a WiFi connection. The terminal 20k references the received Short URL, and thereby automatically obtains desired information. Thereafter, the terminal 20k periodically measures the RSSI of the BLE AP 30h, and in the case in which the BLE AP with the highest received signal strength changes, the terminal 20k breaks the current WiFi connection, and repeats execution of the processes described above.

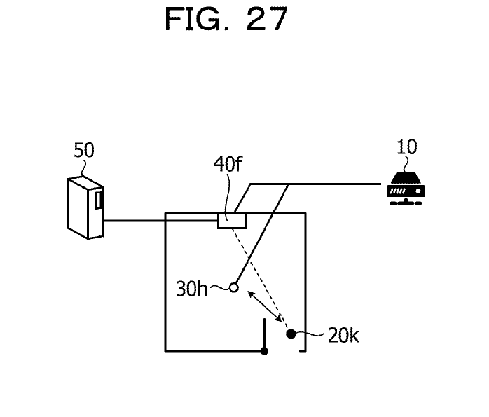

FIG. 27 is a diagram illustrating an example of application of the WiFi connection control system 1 according to Embodiment 5. As illustrated in FIG. 27, when receiving an SSID and PWD, the terminal 20k also receives a Short URL from the control PC 10 through the BLE AP 30h. After that, the terminal 20k references the Short URL received from the BLE AP 30h, and receives relevant information from a file server 50 through the WiFi AP 40. Consequently, by accessing the Short URL included in the advertise signal, the terminal 20k becomes able to automatically obtain information or a document related to the location.

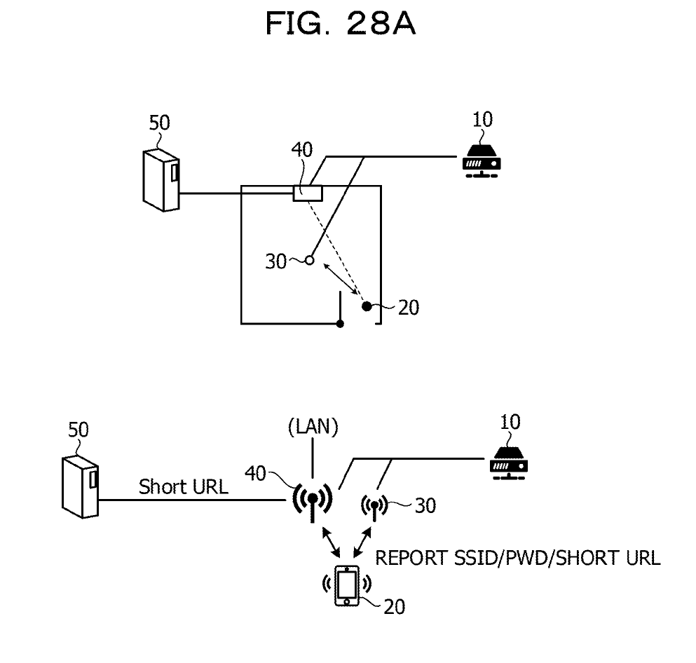

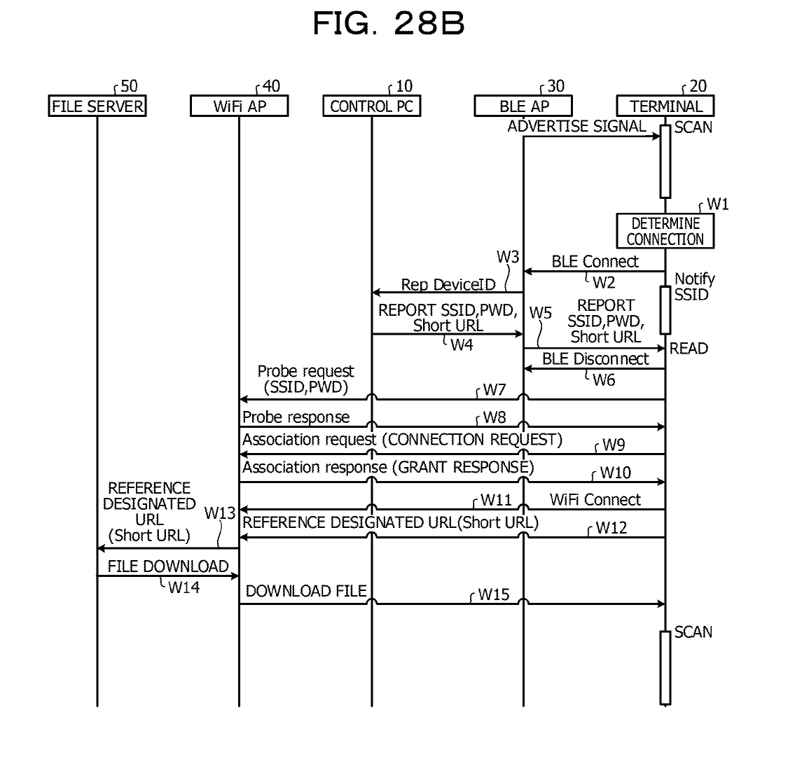

FIG. 28A is a diagram for describing a first half of operation in Case 5-1 of the WiFi connection control system 1 according to Embodiment 5. FIG. 28B is a diagram for describing a second half of operation in Case 5-1 of the WiFi connection control system 1 according to Embodiment 5. FIG. 28B is similar to FIG. 8 referenced in the description of operation according to Embodiment 1, except for W12 to W15. Consequently, steps shared in common will be denoted by reference signs with the same suffix, and detailed description thereof will be omitted. Specifically, each process from steps W1 to W11 of FIG. 28B respectively corresponds to each process from steps S1 to S11 illustrated in FIG. 8. However, in Embodiment 5, in addition to the SSID and PWD, the Short URL is also transmitted and received.

The terminal 20 transmits the Short URL transmitted in W5 to the file server 50 via the WiFi AP 40 (W12, W13). The file server 50 receives the Short URL, and downloads the file designated by the Short URL to the terminal 20 via the WiFi AP 40 (W14, W15).

As described above, in the WiFi connection control system 1 according to Embodiment 5, the controller 12 of the control PC 10 transmits to the terminal 20 a reference URL of information useful to the terminal 20, in addition to the above connection point information (for example, SSID) and password indicating the connection point. Consequently, the user of the terminal 20k may refer to the reference URL to easily and rapidly acquire information or a document related to the location.

### Modification 1

Next, Modification 1 will be described. The connection control system according to Embodiment 1 has a configuration similar to the connection control system according to Embodiment 1 illustrated in FIGS. 2 and 4. Consequently, in Modification 1, components shared in common with Embodiment 1 will be denoted by the same reference signs, the illustration and detailed description of such components will be omitted, and the points that differ from Embodiment 1 will be described mainly. In the connection control system 1 according to Modification 1, when the terminal 20 no longer receives the advertise signal from the BLE AP 30, the controller 22 maintains the current WiFi connection status even if transmits from the BLE monitoring unit 21 are cut off.

In Embodiments 1 to 5, after a WiFi connection established, the terminal 20 may also maintain the WiFi connection even if the terminal 20 moves outside the range of the advertise signal. For example, when the user of the terminal 20 enters an entryway downstairs, the terminal 20 receives the transmit of the SSID/PWD (for example, SSID1/PWD1) of the connection point WiFi AP 40 from the BLE AP 30, and connects to the WiFi AP 40 installed on that floor (for example, 1F). After that, in association with the user going up the stairs, the terminal 20 moves outside the range of the advertise signal of the BLE AP 30, but the connection with the currently connected WiFi AP 40 is still maintained for a predetermined time. Subsequently, when the user finishes going up the stairs, the terminal 20 receives the transmit of the SSID/PWD (for example, SSID2/PWD2) of a new connection point WiFi AP 40 on a higher floor from a new BLE AP 30 on the higher floor (for example, 2F), and switches the WiFi connection to the WiFi AP 40 installed on that floor.

After that, in association with the user going farther up the stairs, the terminal 20 again moves outside the range of the advertise signal of the BLE AP 30, but the connection with the currently connected WiFi AP 40 is still maintained for a predetermined time. Subsequently, when the user finishes going up the stairs, the terminal 20 receives the transmit of the SSID/PWD (for example, SSID3/PWD3) of a new connection point WiFi AP 40 on an even higher floor from a new BLE AP 30 on the higher floor (for example, 3F), and switches the WiFi connection to the WiFi AP 40 installed on that floor.

According to the WiFi connection control system 1 according to Modification 1, by simply arranging a small number of BLE APs 30, optimal WiFi connection switching control may be realized. For example, as a minimum level of arrangement, by arranging BLE APs 30 on the upper and lower parts of a staircase, the control PC 10 is able to connect the terminal 20 to an optimal WiFi AP 40 on each floor without interruption. Note that the WiFi connection may be maintained for a predetermined time after moving outside the range of the advertise signal, or may be maintained until the terminal 20 of the user moves a predetermined distance away from the BLE AP 30.

As described above, in the WiFi connection control system 1 according to Modification 1, after a connection with the terminal 20 is established, the WiFi AP 40 maintains the above connection for a predetermined time after the terminal 20 moves outside the reception range of the above signal (for example, the advertise signal). With this arrangement, WiFi connection switching control with few interruptions becomes possible, even with an arrangement of a few BLE APs 30.

Note that in the above embodiments and modification, Bluetooth (registered trademark) is given as an example of the short-range wireless communication method that the terminal 20 initially uses to connect (also called the second wireless communication method), but the configuration is not limited thereto, and Infrared Data Association (IrDA), radio frequency identification (RFID), ZigBee (registered trademark), or the like may also be used. Likewise for the wireless communication method that the terminal 20 uses when connecting for the second time (also called the first wireless communication method), although WiFi (registered trademark) is given as an example, the configuration is not limited thereto, and the Institute of Electrical and Electronics Engineers (IEEE) 802.11, WiGig (registered trademark), or the like may also be used. Also, throughout the above embodiments and modification, one BLE AP 30 is not necessarily installed for each WiFi AP 40, and multiple BLE APs 30 may also be set up near a single WiFi AP 40. The BLE AP 30 is an example of a second wireless apparatus that uses the second wireless communication method. The WiFi AP 40 is an example of a first wireless apparatus that uses the first wireless communication method.

Furthermore, in the above embodiments and modification, the terminal 20 is described as being a smartphone, but the embodiments are not limited to smartphones, and is also applicable to various types of communication equipment capable of BLE connections and WiFi connections, such as mobile phones and personal digital assistants (PDAs). Also, the wireless communication quality to be measured is not limited to the RSSI value, and may also be a signal-to-interference ratio (SIR) value, a signal-to-interference-and-noise ratio (SINR) value, a reference signal received power (RSRP) value, or a reference signal received quality (RSRQ). Alternatively, channel state information (CSI) such as a channel quality indicator (CQI), a precoding matrix indicator (PMI), a rank indicator (RI), or a layer indicator (LI) is also acceptable.

In addition, each component of the control PC 10 is not limited to being physically configured exactly as depicted in the drawings. In other words, the specific mode in which each apparatus is separated or combined is not limited to that illustrated in the drawings, and all or part thereof may be functionally or physically separated or combined in arbitrary units according to various factors such as load and usage conditions. For example, the WiFi AP setting unit 14 and the traffic monitoring unit 15 of the control PC 10 may be combined as a single component. Alternatively, the BLE monitoring unit 21 and the BLE communication unit 23 of the terminal 20 may be combined as a single component. Conversely, regarding the controller 12, the part that transmits the WiFi AP 40 to act as the connection point to the terminal 20 and the part that periodically changes the SSID and PWD indicating the connection point may be separated. In addition, all or part of the data table 16 may also be connected via a cable or network as an external apparatus of the control PC 10.

Furthermore, in the above description, individual configurations and operations are described for each embodiment and modification. However, a connection control apparatus according to each embodiment and modification may also include components characteristic of another embodiment or modification. Also, combinations of each embodiment and modification are not limited to combinations of two, and arbitrary modes, such as combinations of three or more, may also be adopted. For example, the method of receiving the advertise signal from the BLE AP 30 with the highest received signal strength according to Embodiment 2 may be applied to the control PC 10 according to Embodiment 4. Alternatively, the transmitting of a WiFi AP depending on the terminal user according to Embodiment 3 may be applied to the control PC 10 according to Embodiment 5. Furthermore, a single control PC 10 may also include all of the components described in Embodiments 1 to 5 and Modification 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for connection control, the apparatus comprising:
a memory;
a processor coupled to the memory and configured to
execute a receiving process configured to receive, via a second wireless apparatus installed near a first wireless apparatus, identification information transmitted from a terminal that is located within a range of a second signal from the second wireless apparatus, the identification information being information configured to identify the terminal, and
execute a transmitting process configured to transmit configuration information to the terminal via the second wireless apparatus when the terminal identified by the identification information is allowed to access to the first wireless apparatus that acts as a connection point for the terminal, the configuration information including a parameter for accessing the first wireless apparatus.

2. The apparatus according to claim 1,
wherein the configuration information includes at least connection point information and a password, the connection point information indicating the first wireless apparatus acting as the connection point for the terminal,
wherein the transmitting process is further configured to periodically change the connection point information and the a password.

3. The apparatus according to claim 1,
wherein the second wireless apparatus in the receiving process is one of a plurality of wireless apparatuses configured to perform a communication according to a second communication scheme,
wherein the second signal transmitted from the second wireless apparatus is measured as a highest received signal strength at the terminal.

4. The apparatus according to claim 1,
wherein the transmitting process is further configured to change the parameter included in the configuration information, in accordance with a user of the terminal.

5. The apparatus according to claim 1,
wherein the transmitting process is further configured to change the parameter included in the configuration information, in accordance with network condition detected by the apparatus.

6. The apparatus according to claim 1,
wherein the transmitting process is further configured to add a reference URL of information useful to the terminal into the configuration information to be transmitted to the terminal via the second wireless apparatus.

7. The apparatus according to claim 1,
wherein after the terminal establishes a connection with the first wireless apparatus and then the terminal moves outside a reception range of the signal, the connection between the first wireless apparatus and the terminal is maintained for a predetermined time.

8. A method, performed by a computer for connection control, the method comprising:
executing a receiving process configured to receive, via a second wireless apparatus installed near a first wireless apparatus, identification information transmitted from a terminal that is located within a range of a first signal from the second wireless apparatus, the identification information being information configured to identify the terminal, and
executing a transmitting process configured to transmit configuration information to the terminal via the second wireless apparatus when the terminal identified by the identification information is allowed to access to the first wireless apparatus that acts as a connection point for the terminal, the configuration information including a parameter for accessing the first wireless apparatus.
